(19) United States
(12) Patent Application Publication
(10) Pub. No.: US 2010/0027242 A1
(43) Pub. Date: Feb. 4, 2010

(54) BACKLIGHT UNIT

(75) Inventors: Yasunobu Kishine, Shizuoka (JP); Hideo Nagano, Shizuoka (JP); Ryuichi Katsumoto, Shizuoka (JP); Yoshihiko Sano, Shizuoka (JP); Hiromitsu Wakui, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, TOKYO (JP)

(21) Appl. No.: 12/446,927

(22) PCT Filed: Oct. 19, 2007
(86) PCT No.: PCT/JP2007/070869

§ 371 Date: Oct. 13, 2009

(30) Foreign Application Priority Data
Oct. 27, 2006 (JP) 2006-293170
Oct. 27, 2006 (JP) 2006-293181

(51) Int. Cl. G02F 1/13357

(52) U.S. Cl. 362/97.1

(57) ABSTRACT

A backlight unit, comprising plural linear light sources, and an optical functional sheet, wherein a prism structure having plural prisms is formed on at least one surface of the optical functional sheet, and the values of (Hₙ₋₁+Hₙ)/(Aₙ−Aₙ₋₁) are approximately equivalent, wherein, in a brightness distribution graph that expresses a brightness distribution in the optical functional sheet, A₁ is a peak site and H₁ is a peak height of a first virtual image, A₂ is a peak site and H₂ is a peak height of a second virtual image adjacent to the first virtual image, . . . , Aₙ is a peak site and Hₙ is a peak height of (n)th virtual image adjacent to (n−1)th virtual image, and these virtual images are derived from the plural linear light sources.

### TECHNICAL FIELD

The present invention relates to backlight units, utilized for displays of liquid-crystal display devices, display units, illumination systems, etc., that are equipped with a linear light source and an optical functional sheet that can exhibit light condensing function as well as light diffusing function.

### BACKGROUND ART

In recent years, lens films and/or diffusing sheets have been employed in order to condense light from light sources such as optical waveguides into a front direction or to diffuse the light for use in such applications as liquid crystal display elements and organic EL displays.

In a direct-below-type backlight used for televisions as shown in FIG. 40, for example, the outgoing light from a light source 92 such as optical waveguides enters into a light-condensing film 91 of an optical functional sheet, a part of the incident light is refracted and transmitted at an optical functional sheet 91 to change the emitting angle and emits toward the front direction, and the residual light is reflected to return toward the light sources 92. The reflected light from the optical functional sheet 91 is reflected at the surfaces of the light sources 92, a diffusing plate 93, and a diffusing sheet 94, and then enters to the light-condensing film.

The above-noted construction can improve directional characteristics such that brightness of the light from the light source is made high at the front direction by virtue of the optical functional sheet 91, since the brightness distribution of outgoing light from optical sources is broad and the brightness is inherently low at the front side.

In order to enhance the light diffusing function of the optical functional sheet 91 used in backlight units, surface configuration of a prism structure may be changed depending on pitch cycle of the linear light sources. When the light diffusing function of the optical functional sheet 91 is enhanced, the light condensing function tends to decrease, therefore, in some cases, apex portion or apex angle of prism structure may be somewhat arranged or the prism structure may be partially changed in order to pursue simultaneously the light diffusing function and the light condensing function.

Specifically, unevenness of linear optical sources may be reduced by way of changing the fine prism structure of the optical functional sheet or alignment pitch of linear light sources (see Patent Literature 1, for example); however, there arise such problems as front brightness is lower, molds are necessary for respective alignment pitches of linear light sources as required, and position matching comes to be essential.

Unevenness of linear light sources may also be prevented by way of changing the prism structure depending on alignment pitch cycle of the linear light sources (see Patent Literature 2, for example); however, there arise such problems as front brightness is lower and position matching comes to be essential.

Unevenness of linear light sources may also be prevented by way of setting the apex angle of the prism structure from 40° to 80° thereby to diffuse the light emitted from directly below linear light sources, and sidelobe increase due to the smaller apex angle of prism structure may be addressed by way of providing the apex of prism structure with a curved surface, i.e. curving the apex (see Patent Literature 3, for example); however, there arises such a problem that the light condensing function is lower even though the site matching is unnecessary. The above-noted “sidelobe” refers to such a phenomenon that a peak(s) appears at an oblique direction(s) of about 70° other than front side of 0° depending on the shape of light condensing sheet, even though the purpose is to condense light at front side of displays.

The apex angle of prism structure, capable of providing high diffusing ability, may be calculated by way of molding prisms with V grooves on surface of light diffusing plate and defining a pitch of linear light sources and a distance between the light diffusing plate and the linear light sources (see Patent Literature 4, for example); however, there arises such a problem that the light condensing function is lower. In addition, the diffusing ability may be increased by way of rotating 60° or less prisms, to which V grooves being formed, against a linear light source i.e. increasing the apex angle of cross section of the prism structure; however, there arises such problems that unevenness of linear light sources comes to more visible from other than front side since brightness distribution changes depending on angles and product yield decreases along with increasing the rotation.

Patent Literature 1: Japanese Patent Application Laid-Open (JP-A) No. 06-308485

Patent Literature 2: JP-A No. 2002-352611

Patent Literature 3: JP-A No. 2006-140124

Patent Literature 4: JP-A No. 2006-195276

### DISCLOSURE OF INVENTION

The resent invention aims to solve the problems described above in the art and to attain the object below. That is, it is an object of the present invention to provide a backlight unit that can advance the light diffusing function and also decrease the unevenness of linear light sources without decreasing the light condensing function, generating the sidelobe, or decreasing productivity etc.

The problems described above can be solved by the present invention as follows:

<1> A backlight unit, comprising plural linear light sources, and an optical functional sheet, wherein a prism structure having plural prisms is formed on at least one surface of the optical functional sheet, and the values of (Hₙ₋₁+Hₙ)/(Aₙ−Aₙ₋₁) are approximately equivalent,

wherein, in a brightness distribution graph that expresses a brightness distribution in the optical functional sheet, Bmax is the maximum brightness and Bmin is the minimum brightness at the central portion of the backlight unit in the optical functional sheet; A₁ is a peak site and H₁ is a peak height of a first virtual image, A₂ is a peak site and H₂ is a peak height of a second virtual image adjacent to the first virtual image, . . . , Aₙ₋₁ is a peak site and Hₙ₋₁ is a peak height of (n−1)th virtual image adjacent to (n−2)th virtual image, and Aₙ is a peak site and Hₙ is a peak height of (n)th virtual image adjacent to (n−1)th virtual image, and these virtual images are derived from the plural linear light sources, and

the virtual image corresponds to a peak of which the peak height Hₙ satisfies the condition of Hₙ≧0.3×(Bmax−Bmin); and the brightness distribution graph represents a brightness distribution of the optical functional sheet in which the backlight unit is equipped with neither a diffusing sheet nor a diffusing plate.

In accordance with <1>, the light diffusing function can be enhanced without decreasing the light condensing function and also the unevenness of linear source lights can be reduced.

<2> The backlight unit according to <1>, wherein the ratios of the sum of peak height of one virtual image, among plural virtual images derived from the plural linear light sources, and peak height of the virtual image adjacent to the one virtual image, to the distance between the peek sites of the adjacent images, are approximately equivalent.

<3> A backlight unit, comprising plural linear light sources, and an optical functional sheet, wherein a prism structure having plural prisms is formed on at least one surface of the optical functional sheet, virtual images of the optical functional sheet derived from the plural linear light sources are approximately equivalent in terms of their brightnesses, and distances between adjacent virtual images of the optical functional sheet are approximately equivalent.

In accordance with <3>, the virtual images of the optical functional sheet derived from the plural linear light sources are approximately equivalent in terms of their brightnesses, and distances between adjacent virtual images of the optical functional sheet are approximately equivalent, therefore, the light diffusing function can be enhanced without decreasing the light condensing function and also the unevenness of linear source lights can be reduced.

<4> The backlight unit according to <3>, wherein brightness peaks exist in an approximately equivalent number and in an approximately equivalent height with an approximately equivalent space within each region of R₁ to Rₙ, in a brightness distribution graph that expresses brightness distribution in the optical functional sheet,

wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among plural linear light sources.

<5> The backlight unit according to any one of <1> to <4> wherein the backlight unit further comprises a diffusing sheet, the value of standard deviation of brightness within region Rₙ of the optical functional sheet divided by the average value of brightness within region Rₙ of the optical functional sheet is less than 0.0100,

wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among plural linear light sources.

<6> The backlight unit according to any one of <1> to <5>, wherein the aligning direction of prisms is inclined from the orientation direction of the linear light sources.

<7> The backlight unit according to <1>, wherein the distance “d” between the linear light sources and the optical functional sheet is selected such that the values of (Hₙ₋₁+Hₙ)/(Aₙ−Aₙ₋₁) are approximately constant.

In accordance with <7>, the distance “d” between the linear light sources and the optical functional sheet is selected such that the values of (Hₙ₋₁+Hₙ)/(Aₙ−Aₙ₋₁) are approximately constant, therefore, the light diffusing function can be enhanced without decreasing the light condensing function and also the unevenness of linear source lights can be reduced.

<8> The backlight unit according to <7>, wherein the ratios of the sum of peak height of one virtual image, among plural virtual images derived from plural linear light sources, and peak height of the virtual image adjacent to the one virtual image, to the distance between the peek sites of the adjacent images, are approximately equivalent.

<9> The backlight unit according to <3>, wherein the distance “d” between the linear light sources and the optical functional sheet is selected such that the distances between adjacent virtual images are approximately constant in the optical functional sheet.

In accordance with <9>, virtual images of the optical functional sheet derived from the plural linear light sources are approximately equivalent in terms of their brightnesses, and the distance “d” between the linear light sources and the optical functional sheet is selected such that the distances between adjacent virtual images are approximately constant in the optical functional sheet, therefore, the light diffusing function can be enhanced without decreasing the light condensing function and also the unevenness of linear source lights can be reduced.

<10> The backlight unit according to any one of <7> to <9> wherein the value of standard deviation of brightness within region Rₙ of the optical functional sheet divided by the average value of brightness within region Rₙ of the optical functional sheet is no more than 0.540,

wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among plural linear light sources.

<11> The backlight unit according to any one of <7> to <10>, wherein the distance “d” between the linear light sources and the optical functional sheet is calculated from Equation (1) below based on refractive index “n” of the optical functional sheet, bevel angle θ of emitting face of prisms against light emitted from the linear light sources, and pitch “p” of the linear light sources,

d=(f(p)−27.9n−0.473θ+65.7)/0.557±5 mm Equation (1)

wherein f(p) is a distance between a nodal line and a virtual image that is nearest to the nodal line, and is a function of the pitch “p”; in which the nodal line is one between a flat surface, which containing a linear light source among the plural linear light sources and being perpendicular to the optical functional sheet, and a flat surface, which containing the optical functional sheet; the virtual image is one except for ones on the nodal line among the virtual images of the optical functional sheet derived from a linear light source.

<12> The backlight unit according to any one of <7> to <11>, wherein each of the prisms is a semi-four-sided pyramid, and has two first emitting faces opposing each other and two second emitting faces opposing each other, sum of areas of the two first emitting faces is approximately equivalent with the area of one of the two second emitting faces, and f(P) is approximately p/3 or approximately 2p/3, when the aligning direction of the prisms is parallel to the orientation direction of the linear light sources.

<13> The backlight unit according to any one of <7> to <11>, wherein one optical functional sheet having prisms with V-shaped grooves is disposed, and f(P) is approximately p/4 or approximately 3p/4, when the aligning direction of the prisms is parallel to the orientation direction of the linear light sources.

<14> The backlight unit according to any one of <7> to <11>, wherein each of the prism is a regular four-sided pyramid, and f(p)=p/(8×sin X°) or =p/(5×sin X°), when the aligning direction of the prisms is inclined X° from the orientation direction of the linear light sources.

<15> The backlight unit according to any one of <7> to <11>, wherein two optical functional sheets having prisms with V-shaped grooves are disposed orthogonally, and f(p) is approximately p/(8×sin X°+8×cos X°) or approximately p/(6.5×sin X°+6.5×cos X°), when the aligning direction of prisms of one optical functional sheet is inclined X° from the orientation direction of the linear light sources.

The present invention can solve the problems described above in the art, that is a backlight unit can be provided that advances the light diffusing function and also decreases the unevenness of linear light sources without decreasing the light condensing function, generating the sidelobe, or decreasing productivity etc. Also, moire with liquid crystal pixels can be prevented when the backlight unit is used in liquid crystal display systems.

### BRIEF DESCRIPTION OF DRAWINGS

FIG. 1 is a perspective view that shows a construction of an optical functional sheet of the inventive backlight unit.

FIG. 2 is a block diagram that shows a construction of production system used for a method for producing the optical functional sheet shown in FIG. 1.

FIG. 3A is a plan view that shows a positional relation of linear light sources and an optical functional sheet where the shape of prisms of the optical functional sheet shown in FIG. 1 is a regular four-sided pyramid of concave or convex.

FIG. 3B is a graph explaining that the distance between adjacent virtual images is changed depending on brightness of the virtual images when the brightnesses of the virtual images derived from linear light sources are not constant in the optical functional sheet.

FIG. 3C is a view that explains peak height.

FIG. 3D is a view that explains central portion of a backlight unit where the number of plural linear light sources is “n” (even number).

FIG. 3E is a view that explains central portion of a backlight unit where the number of plural linear light sources is eight.

FIG. 3F is a view that explains central portion of a backlight unit where the number of plural linear light sources is “n” (odd number).

FIG. 3G is a view that explains central portion of a backlight unit where the number of plural linear light sources is seven.

FIG. 4A is a plain view that shows a positional relation of linear light sources and an optical functional sheet where the shape of prisms of the optical functional sheet shown in FIG. 1 is a concave or convex semi-four-sided pyramid with an aspect ratio of 1.5.

FIG. 4B is a view showing that an end of a virtual image derived from a linear light source and an end of a virtual image derived from another linear light source are overlapped, in which the aligning direction of prisms of semi-four-sided pyramid is not inclined from the orientation direction of linear light sources.

FIG. 4C is a view showing that a virtual image derived from a linear light source and a virtual image derived from another linear light source are moderately overlapped, in which the aligning direction of prisms of semi-four-sided pyramid is inclined from the orientation direction of linear light sources.

FIG. 5 is a plan view that shows a positional relation of linear light sources and an optical functional sheet where the shape of prisms of the optical functional sheet shown in FIG. 1 is a concave or convex truncated pyramid.

FIG. 6 is a view that shows a positional relation of linear light sources and an optical functional sheet where the shape of prisms of the optical functional sheet shown in FIG. 1 is a concave or convex semi-truncated pyramid.

FIG. 7 is a view that shows a positional relation of linear light sources and an optical functional sheet where the shape of prisms of the optical functional sheet shown in FIG. 1 is a concave or convex semi-four-sided pyramid.

FIG. 8 is a view that shows a positional relation of linear light sources and an optical functional sheet shown in FIG. 1.

FIG. 9 is a plan view of the optical functional sheet shown in FIG. 1 where the shape of prisms is a concave semi-four-sided pyramid with an aspect ratio of 1.5.

FIG. 10 is a view explaining the sites where virtual images generate in the optical functional sheet shown in FIG. 9 when f(p) is p/3.

FIG. 11 is a view explaining the sites where virtual images generate in the optical functional sheet shown in FIG. 9 when f(p) is 2p/3.

FIG. 12 is a plain view of the optical functional sheet shown in FIG. 1 where the shape of prisms is a concave regular four-sided pyramid.

FIG. 13 is a plain view of the optical functional sheet shown in FIG. 1 where the shape of prisms is a concave regular four-sided pyramid, and the aligning direction of prisms is inclined 18.4° from the aligning direction of linear light sources.

FIG. 14 is a perspective view of the optical functional sheet shown in FIG. 1 where the shape of prisms is formed with V-shaped grooves.

FIG. 15 is a view that shows a construction of a backlight unit according to the present invention.

FIG. 16 is a photo image of the optical functional sheet of Example 3-A.

FIG. 17 is a photo image of the optical functional sheet taken under the same condition as that of FIG. 16 except that the diffusing sheet was not disposed.

FIG. 18 is a photo image of the optical functional sheet of Example 6-A.

FIG. 19 is a photo image of the optical functional sheet taken under the same condition as that of FIG. 18 except that the diffusing sheet was not disposed.

FIG. 20 is a photo image of the optical functional sheet of Example 8-A.

FIG. 21 is a photo image of the optical functional sheet taken under the same condition as that of FIG. 20 except that the diffusing sheet was not disposed.

FIG. 22 is a photo image of the optical functional sheet of Example 11-A.

FIG. 23 is a photo image of the optical functional sheet taken under the same condition as that of FIG. 22 except that the diffusing sheet was not disposed.

FIG. 24 is a photo image of the optical functional sheet of Comparative Example 5-A.

FIG. 25 is a photo image of the optical functional sheet taken under the same condition as that of FIG. 24 except that the diffusing sheet was not disposed.

FIG. 26 is a photo image of the optical functional sheet of Example 16-A.

FIG. 27 is a photo image of the optical functional sheet taken under the same condition as that of FIG. 26 except that the diffusing sheet was not disposed.

FIG. 28 is a photo image of the optical functional sheet of Comparative Example 8-A.

FIG. 29 is a photo image of the optical functional sheet taken under the same condition as that of FIG. 28 except that the diffusing sheet was not disposed.

FIG. 30 shows brightness distributions in the optical functional sheets of Examples 2-A to 4-A and 6-A.

FIG. 31 shows brightness distributions in the optical functional sheets of Examples 7-A to 9-A and Comparative Example 2-A.

FIG. 32 shows brightness distributions in the optical functional sheets of Examples 10-A to 12-A and Comparative Example 5-A.

FIG. 33 shows brightness distributions in the optical functional sheets of Examples 16-A and Comparative Example 8-A.

FIG. 34 is a view explaining that brightness peaks P exist in an approximately equivalent number with an approximately equivalent space within each region of R1 to R3.

FIG. 35 is an image that explains moire.

FIG. 36 is an image that explains moire.

FIG. 37 is a graph that shows the result of simulation calculation of unevenness evaluation.

FIG. 38 is a view that shows a backlight unit with a reflective plate.

FIG. 39 is a view that shows a backlight unit with a reflective plate and a reflective sheet.

FIG. 40 is a schematic cross section that exemplarily shows a conventional direct-below-type backlight.

### BEST MODE FOR CARRYING OUT THE INVENTION

### Backlight Unit

The backlight unit of the present invention includes a linear light source, an optical functional sheet, and other members.

### Linear Light Source

The optical light source may be cold cathode tubes, hot cathode tubes, linearly aligned LEDs, or combinations of LEDs and optical waveguides. The cold cathode tubes or the hot cathode tubes are not necessarily linear, but may be allowable to have such shapes as two parallel tubes are connected by a semicircle to form U-like shape, three parallel tubes are connected by two semicircles to form N-like shape, or four parallel tubes are connected by three semicircles to form W-like shape.

The linear light source is preferably cold cathode tubes from the viewpoint of uniform brightness, or preferably combinations of linearly aligned LEDs and optical waveguides from the viewpoint of luminous efficiency.

### Optical Functional Sheet

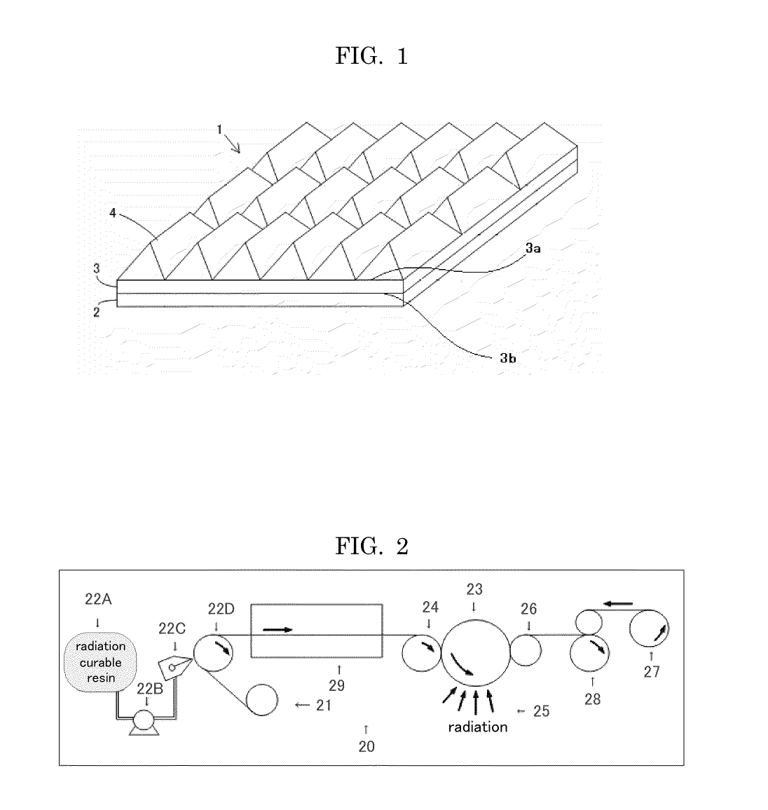

FIG. 1 is a perspective view that shows a partial construction of an inventive optical functional sheet. As shown in FIG. 1, the inventive optical functional sheet 1 includes at least a substrate 3, on which prisms 4 described later are formed, and an optional support 2 to support the substrate 3. The support 2 and the substrate 3 may be formed of a resin.

The substrate 3 has an entrance face 3b (hereinafter sometimes referred to as a “reference face 3b”) into which light emitted from a light source such as backlights enters through the support 2 and a prism-forming face 3a, on which plural prisms 4 being formed approximately entirely to condense the light at a predetermined direction, at the opposite side of the entrance face 3b.

The configuration of the optical functional sheet 1 is exemplified by prism sheets and lenticular lenses, and also diffraction gratings.

The inventive optical functional sheet 1 may include other layers such as light diffusing layers, back layers, and intermediate layers as required.

### Support

The shape of the support 2 may be properly selected depending on the application, for example, may be rectangular, square, or circular.

The structure of the support 2 may be properly selected depending on the application, for example, may be monolayer or multilayer.

The size of the support 2 may be properly selected depending on the application.

The material of the support 2 (sheet) may be properly selected as long as being transparent and having an adequate strength, for example, may be resin films, papers (resin coated papers, synthetic papers, etc.), metal foils (aluminum webs), or the like. Specifically, the material of the resin film may be conventional ones such as polyethylene, polypropylene, polyvinyl chloride, polyvinylidene chloride, polyvinyl acetate, polyester, polyolefin, acryl, polystyrene, polycarbonate, polyamide, PET (polyethylene terephthalate), twin-axis stretched polyethylene terephthalate, polyamide-imide, polyimide, aromatic polyamide, cellulose acylate, cellulose triacetate, cellulose acetate propionate, and cellulose diacetate. Among these, polyester, cellulose acylate, acryl, polycarbonate, and polyolefin are preferable in particular.

The width of the support 2 is typically 0.1 to 3 meters, the length of the support 2 is typically 1,000 to 100,000 meters, and the thickness of the support 2 is typically 1 to 300 μm; the other sizes may be allowable.

The thickness of the support 2 can be measured, for example, by use of a film thickness meter in which the thickness of the support 2 is measured through clipping the support 2 by the meter or a non-contacting film thickness meter in which the thickness of the support 2 is measured through making use of optical interference.

The support 2 may be preliminarily subjected to corona discharge, plasma treatment, adhesion-facilitating treatment, heat treatment, or dust-removing treatment. The surface roughness Ra of the support 2 is preferably 3 to 10 nm at a cutoff value of 0.25 mm.

The support 2 may be those to which an undercoat layer such as adhesive layers being preliminarily applied and dried to cure or those to which other functional layers being formed on the back side. The structure of the support 2 may also be of monolayer or two or more layers.

The haze of the support is no more than 50%, preferably no more than 40%, more preferably no more than 30%, and still more preferably no more than 20%. The haze of above 50% may considerably decrease the light-condensing efficiency.

The haze is a measure to express an obscure level, and is evaluated on the basis of values measured, for example, by measuring devices such as a haze meter (model HZ-1, by Suga Test Instruments Co.) in accordance with JIS 7105.

### Apparatus and Method for Producing Optical Functional Sheet

The apparatus and the method for producing the optical functional sheet may be properly selected as long as capable of forming fine concavo-convex shape, for example, a method using the production apparatus 20 shown in FIG. 2 is preferably employed.

The production apparatus 20 is constructed from a sheet-feeding unit 21, a coating unit 22, a drying unit 29, an emboss roll 23 of a concavo-convex roll, a nip roll 24, a resin-curing unit 25, a peeling roll 26, a protective-film feeding unit 27, and a sheet-winding unit 28.

The sheet-feeding unit 21 acts to feed a sheet, and is constructed from a discharging roll etc. to which the sheet is wound.

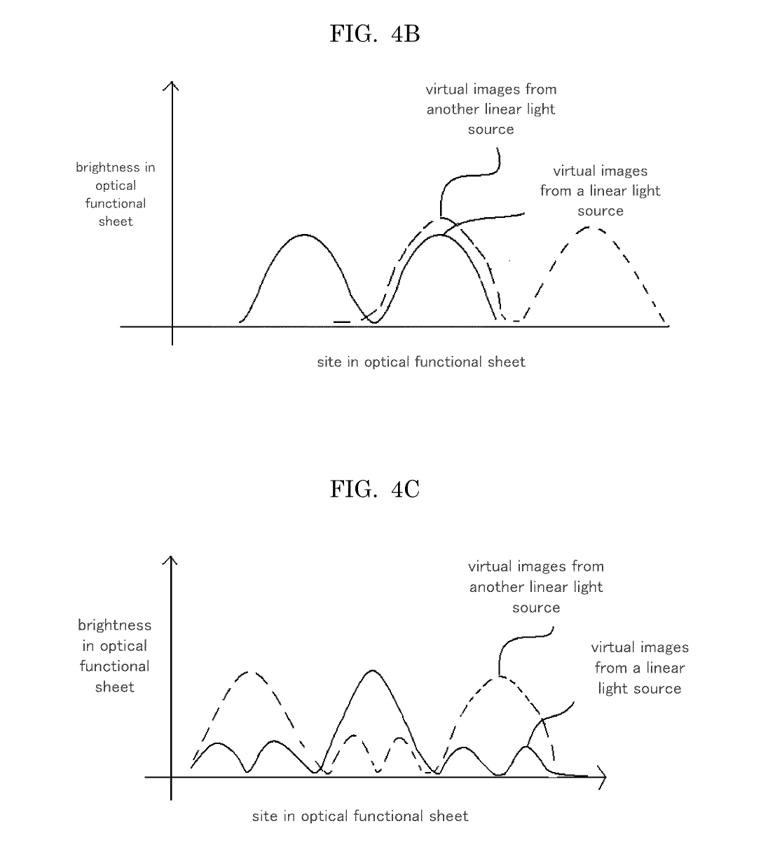

The coating unit 22 is a device to coat a radiation curable resin on the surface of the sheet, and is constructed from a reservoir 22A to supply the radiation curable resin, a supplying device (pump) 22B, a coating head 22C, a supporting roller 22D to wind up and to support the sheet at coating thereof, and a piping to supply the radiation curable resin from the reservoir 22A to the coating head 22C. The coating head in FIG. 4 is one of an extrusion-type die coater.

The drying unit 29 may be properly selected from conventional ones, such as tunnel drying devices as shown in FIG. 2 for example, as long as capable of drying uniformly coating liquid applied on the sheet. Specific examples are those of radiation heat systems using heaters, hot-air circulating systems, far-infrared ray systems, or vacuum systems.

It is necessary that the emboss roll 23 has a surface configuration with accuracy, mechanical strength, and circularity capable of transferring a concavo-convex pattern onto the sheet surface. The emboss roll 23 is preferably of metal rolls, for example.

A fine regular concavo-convex pattern is formed on the outer circumference surface of the emboss roll 23. It is necessary that the fine regular concavo-convex pattern is of the reverse configuration to the fine regular concavo-convex pattern on the surface of the emboss sheet as a produced article.

The emboss sheet as a produced article may be of lenses such as lenticular lenses or prism lenses two-dimensionally aligned into a fine concavo-convex pattern; of lenses such as fry eye lenses three-dimensionally aligned into a fine concavo-convex pattern; or of flat plate lenses in which fine petrosae such as circular cones or pyramids are paved in X-Y directions; the fine regular concavo-convex pattern on the outer circumference surface of the emboss roll 23 is made correspond with these lenses.

The method to form the fine regular concavo-convex pattern on the outer circumference surface of the emboss roll 23 may be carried out by cutting and processing the surface of the emboss roll 23 using a diamond bite (single point), or by directly forming the concaves and convexes on the surface of the emboss roll 23 by way of photo etching, electron beam lithography, laser processing, or the like. The emboss roll 23 may also be produced in a way that a concavo-convex pattern is formed on a surface of thin metal plate by photo etching, electron beam lithography, laser processing, photo molding, or the like, and the metal plate is fixed around a roll. In addition, the emboss roll 23 may also be produced in a way that a concavo-convex pattern is formed on a surface of a material, which being more workable than metal, by photo etching, electron beam lithography, laser processing, photo molding, or the like, then a reverse pattern mold is formed by electroforming etc. to prepare a thin metal plate, and the metal plate is fixed around a roll. This process has a feature that plural identical plates can be formed from an original mold (mother) when the reverse pattern mold is formed by electroforming etc.

It is preferred that the surface of the emboss roll 23 is applied a demolding treatment. The application of the demolding treatment on the surface of the emboss roll 23 may appropriately maintain the configuration of the fine concavo-convex pattern. The demolding treatment may be properly selected from various conventional ones depending on the purpose; for example, the demolding treatment may be a coating of a fluorine resin. It is preferred that the emboss roll 23 is provided with a driving unit. The emboss roll 23 rotates counterclockwise as the arrow in FIG. 2.

The nip roll 24 forms a pair with the emboss roll 23 to process and mold a sheet by roll-pressure, therefore, is necessary to have a certain mechanical strength, circularity, etc. In cases where the longitudinal modulus (Young's modulus) is unduly small at the surface of the nip roll 24, the molding-processing by the roll is likely to be insufficient, and in cases where being unduly large, defects tend to generate due to excessive sensitivity against inclusion of foreign matters like dusts; as such, the longitudinal modulus is preferably within an appropriate range. It is preferred that the nip roll 24 is provided with a driving unit. The emboss roll 24 rotates clockwise as the arrow in FIG. 2.

It is preferred that either the emboss roll 23 or the nip roll 24 is provided with a pressure unit so as to apply a certain suppress strength between the emboss roll 23 and the nip roll 24. It is also preferred that either the emboss roll 23 or the nip roll 24 is provided with a fine adjustment unit so as to control correctly the gap or clearance and the pressure between the emboss roll 23 and the nip roll 24.

The resin-curing unit 25 is a radiation irradiating unit at the site where facing the emboss roll 23 downstream the nip roll 24. The resin-curing unit 25 irradiates with a radiation that transmits the sheet to cure the resin layer. It is preferred that the radiation is adjustable depending on curing properties of resins and the strength of the radiation is variable depending on the conveying velocities of sheets. The resin-curing unit 25 is exemplified by a columnar lamp having a length that is approximately the same as the width of the sheet. Plural columnar lamps may be disposed in parallel or a reflecting plate may be further disposed at the backside of the columnar lamp.

The peeling roll 26 forms a pair with the emboss roll 23 to peel the sheet from the emboss roll 23, therefore, is necessary to have a certain mechanical strength and circularity.

Specifically, at the peeling site, the sheet is peeled from the emboss roll 23 to wind onto the peeling roll 26 through pinching the sheet, which being wound to the circumferential surface of the emboss roll 23, by the rotating emboss roll 23 and peeling roll 26. In order to assure this action, the peeling roll 26 is preferably provided with a driving unit. The peeling roll 26 rotates clockwise.

The peeling roll 26 may be further provided with a cooling unit to cool the sheet at separating in order to assure the peeling when the temperature of the resin etc. rises upon curing.

The curing process may be carried out in a manner that plural facing backup rolls (not shown) are disposed from the site where the emboss roll 23 presses (nine o'clock position) to the site where the sheet is separated (three o'clock position) and the sheet is pressed by the plural backup rolls and the emboss roll 23 while the curing.

The sheet-winding unit 28, which stores the peeled sheet, is constructed from a winding-up roll etc. to take up the sheet. The sheet-winding unit 28 feeds the protective film, supplied from the adjacent protective-film feeding unit 27, on the surface of the sheet, then both of the films are superimposed to be stored on the sheet-winding unit 28.

The production apparatus 20 may be further provided guide rollers between the coating unit 22 and the emboss roll 23 and/or between the peeling roll 26 and the sheet-winding unit 28 in order to construct the conveying line and other optional members such as tension rollers to eliminate slack of the sheet W.

The operation of the production apparatus 20 will be explained in the following. The sheet is sent out at a constant rate from the sheet-feeding unit 21. The sheet is fed into the coating unit 22 to coat a resin on the surface of the sheet. After the coating, solvent in the coating liquid is evaporated by the drying unit 29. The sheet is then fed into the molding unit formed of the emboss roll 23 and the nip roll 24. Thereby the molding unit works to roll-mold by way of pressing the continuously running sheet between the rotating emboss roll 23 and nip roll 24 at the nine o'clock position of the emboss roll 23. That is, the sheet is wound onto the rotating emboss roll 23 and the concavo-convex pattern on the surface of the emboss roll 23 is transferred to the resin layer.

The resin layer is then irradiated with a radiation through the sheet by the resin-curing unit 25 to cure the resin layer under the condition that the sheet is wound onto the emboss roll 23. Then the sheet is peeled from the emboss roll 23 by way of winding the sheet onto the peeling roll 26 at three o'clock position of the emboss roll 23.

The sheet may be irradiated again with a radiation to further promote the curing after peeling the sheet (not shown in FIG. 2).

The peeled sheet is conveyed into the sheet-winding unit 28, the protective film, supplied from the protective-film feeding unit 27, is fed on the surface of the sheet, then both of the films are wound to be stored on the sheet-winding unit 28 in a condition that both films being superimposed.

In this way, the resin layer is formed on the sheet surface with a uniform thickness, and the embossing by the emboss roll can be stable and uniform. Consequently, concavo-convex sheet having a fine regular concavo-convex pattern on the surface can be produced with high quality without defects.

The production apparatus 20 is exemplarily explained as above in terms of the embodiment using a roll-like emboss roll 23, alternatively, a belt such as an endless belt having a concavo-convex pattern of emboss configuration may be used since such a belt may provide a similar effect and operation as those of the columnar roll.

### Material of Optical Functional Sheet

The material of the sheet for the optical functional sheet is exemplified by resin films, papers (resin coated papers, synthetic papers, etc.), metal foils (aluminum webs), or the like.

The material of the resin film is exemplified by polyethylene, polypropylene, polyvinyl chloride, polyvinylidene chloride, polyvinyl acetate, polyester, polyolefin, acryl, polystyrene, polycarbonate, polyamide, PET (polyethylene terephthalate), twin-axis stretched polyethylene terephthalate, polyamide-imide, polyimide, aromatic polyamide, cellulose acylate, cellulose triacetate, cellulose acetate propionate, and cellulose diacetate. Among these, polyester, cellulose acylate, acryl, polycarbonate, and polyolefin are preferable in particular.

The sheet is typically 0.1 to 3 meters wide, 1,000 to 100,000 meters long, and 1 to 300 μm thick; and the other sizes may be allowable.

The sheet may be preliminarily subjected to corona discharge, plasma treatment, adhesion-facilitating treatment, heat treatment, or dust-removing treatment. The surface roughness Ra of the support is preferably 3 to 10 nm at a cutoff value of 0.25 mm.

The sheet may be those to which an undercoat layer such as adhesive layers being preliminarily applied and dried to cure or those to which other functional layers being formed on the back side. The structure of the sheet may also be of monolayer or two or more layers. The sheet is preferably transparent or semi-transparent so as to transmit light.

The resin used in the resin layer is exemplified by compounds containing a reactive group such as (meth)acryloyl group, vinyl group and epoxy group and compounds, capable of reacting with the compounds containing a reactive group upon irradiating a radiation like UV rays, that generates active species such as radicals and cations.

The combinations of compounds (monomers) containing a reactive group of unsaturated group such as (meth)acryloyl group and vinyl group and photo-radical polymerization initiators that generate a radical by action of light are preferable from the viewpoint of prompt curing in particular. Among these, (meth)acryloyl group-containing compounds are preferable, such as (meth)acrylates, urethane (meth)acrylates, epoxy (meth)acrylates, and polyester (meth)acrylate. The (meth)acryloyl group-containing compounds may be those containing one or more (meth)acryloyl groups. The compounds (monomers) containing a reactive group of unsaturated group such as (meth)acryloyl group and vinyl group may be used alone or in combination of two or more as required.

As regards the (meth)acryloyl group-containing compounds, monofunctional monomers, which contain one (meth)acryloyl group, are exemplified by isobornyl(meth)acrylate, bornyl(meth)acrylate, tricyclodecanyl(meth)acrylate, dicyclopentanyl(meth)acrylate, dicyclopentenyl(meth)acrylate, cyclohexyl(meth)acrylate, benzyl(meth)acrylate, 4-butylcyclohexyl(meth)acrylate, acryloylmorpholine, 2-hydroxyethyl(meth)acrylate, 2-hydroxypropyl(meth)acrylate, 2-hydroxybutyl(meth)acrylate, methyl(meth)acrylate, ethyl(meth)acrylate, propyl(meth)acrylate, isopropyl(meth)acrylate, butyl(meth)acrylate, amyl(meth)acrylate, isobutyl(meth)acrylate, t-butyl(meth)acrylate, pentyl(meth)acrylate, isoamyl(meth)acrylate, hexyl(meth)acrylate, heptyl(meth)acrylate, octyl(meth)acrylate, isooctyl(meth)acrylate, 2-ethylhexyl(meth)acrylate, nonyl(meth)acrylate, decyl(meth)acrylate, isodecyl(meth)acrylate, undecyl(meth)acrylate, dodecyl(meth)acrylate, lauryl(meth)acrylate, stearyl(meth)acrylate, isostearyl(meth)acrylate, tetrahydrofurfuryl(meth)acrylate, butoxyethyl(meth)acrylate, ethoxydiethyleneglycol(meth)acrylate, polyethyleneglycolmono(meth)acrylate, polypropyleneglycolmono(meth)acrylate, methoxyethyleneglycol(meth)acrylate, ethoxyethyl(meth)acrylate, methoxypolyethyleneglycol(meth)acrylate, and methoxypolypropyleneglycol(meth)acrylate.

Monofunctional monomers containing an aromatic group are exemplified by phenoxyethyl(meth)acrylate, phenoxy-2-methylethyl(meth)acrylate, phenoxyethoxyethyl(meth)acrylate, 3-phenoxy-2-hydroxypropyl(meth)acrylate, 2-phenylphenoxyethyl(meth)acrylate, 4-phenylphenoxyethyl(meth)acrylate, 3-(2-phenylphenyl)-2-hydroxypropyl(meth)acrylate, (meth)acrylate of p-cumylphenol reacted with ethyleneoxide, 2-bromophenoxyethyl(meth)acrylate, 4-bromophenoxyethyl(meth)acrylate, 2,4-dibromophenoxyethyl(meth)acrylate, 2,6-dibromophenoxyethyl(meth)acrylate, 2,4,6-tribromophenyl(meth)acrylate, and 2,4,6-tribromophenoxyethyl(meth)acrylate.

Examples of the commercially available monofunctional monomers containing an aromatic group include Aronix M113, M110, M101, M102, M5700, TO-1317 (by Toagosei Co.), Viscoat #192, #193, #220, 3BM (by Osaka Organic Chemical Industry Co.), NK Ester AMP-10G, AMP-20G (by Shin-Nakamura Chemical Co.), Light Acrylate PO-A, P-200A, Epoxy Ester M-600A, Light Ester PO (Kyoeisha Chemical Co.), New Frontier PHE, CEA, PHE-2, BR-30, BR-31, BR-31M, BR-32 (by Dai-ichi Kogyo Seiyaku Co.), etc.

Examples of unsaturated monomers containing two (meth)acryloyl groups per molecule are alkyldiol diacrylates such as 1,4-butanediol diacrylate, 1,6-hexanediol diacrylate and 1,9-nonanediol diacrylate; ethyleneglycol di(meth)acrylate, tetraethyleneglycol diacrylate, polyalkyleneglycol diacrylates such as tripropyleneglycol diacrylate; and neopentylglycol di(meth)acrylate, tricyclodecanemethanol diacrylate, etc.

Examples of the unsaturated monomers containing a bisphenol skeleton are bisphenol A (meth)acrylate added with ethylene oxide, tetrabromobisphenol A (meth)acrylate added with ethylene oxide, bisphenol A (meth)acrylate added with propylene oxide, tetrabromobisphenol A (meth)acrylate added with propylene oxide, bisphenol A epoxy(meth)acrylate synthesized by epoxy ring-opening reaction of bisphenol A diglycidylether and (meth)acrylic acid, tetrabromobisphenol A epoxy(meth)acrylate synthesized by epoxy ring-opening reaction of tetrabromobisphenol A diglycidylether and (meth)acrylic acid, bisphenol F epoxy(meth)acrylate synthesized by epoxy ring-opening reaction of bisphenol F diglycidylether and (meth)acrylic acid, and tetrabromobisphenol F epoxy(meth)acrylate synthesized by epoxy ring-opening reaction of tetrabromobisphenol F diglycidylether and (meth)acrylic acid.

Examples of the commercially available unsaturated monomers having such a configuration are Viscoat #700, #540 (by Osaka Organic Chemical Industry Co.), Aronix M-208, M-210 (by Toagosei Co.), NK Ester BPE-100, BPE-200, BPE-500, A-BPE-4 (by Shin-Nakamura Chemical Co.), Light Ester BP-4EA, BP-4PA, Epoxy Ester 3002M, 3002A, 3000M, 3000A (Kyoeisha Chemical Co.), KAYARAD R-551, R-712 (by Nippon Kayaku Co.), BPE-4, BPE-10, BR-42M (by Dai-ichi Kogyo Seiyaku Co.), Lipoxy VR-77, VR-60, VR-90, SP-1506, SP-1506, SP-1507, SP-1509, SP-1563 (by Showa Highpolymer Co.), Neopol V779, Neopol V779MA (by Japan U-PiCA Co.).

Examples of the trivalent or more (meth)acrylate unsaturated monomer are trivalent or more (meth)acrylate of polyvalent alcohol such as trimethylolpropane tri(meth)acrylate, pentaerythritol tri(meth)acrylate, trimethylolpropane trioxyethyl(meth)acrylate, and tris(2-acryloyloxyethyl)isocyanurate.

Commercially available examples of the trivalent or more (meth)acrylate unsaturated monomer are Aronix M305, M309, M310, M315, M320, M350, M360, M408 (by Toagosei Co.), Viscoat #295, #300, #360, GPT, 3PA, #400 (by Osaka Organic Chemical Industry Co.), NK Ester TMPT, A-TMPT, A-TMM-3, A-TMM-3L, A-TMMT (by Shin-Nakamura Chemical Co.), Light Acrylate TMP-A, TMP-6EO-3A, PE-3A, PE-4A, DPE-6A (Kyoeisha Chemical Co.), KAYARAD PET-30, GPO-303, TMPTA, TPA-320, DPHA, D-310, DPCA-20, DPCA-60 (by Nippon Kayaku Co.), etc.

The (meth)acryloyl group-containing compound may be incorporated additionally with a urethane(meth)acrylate oligomer in view of appropriate viscosity. Examples of the urethane(meth)acrylate include polyether polyols such as polyethyleneglycol and polytetramethylglycol; polyester polyols synthesized by reaction between dibasic acids such as succinic acid, adipic acid, azelaic acid, sebacic acid, phthalic acid, tetrahydrophthalic anhydride and tetrahydrophthalic anhydride and diols such as ethyleneglycol, propylene, diethyleneglycol, triethyleneglycol, tetraethyleneglycol, dipropylene glycol, 1,4-butanediol, 1,6-hexanediol, neopentylglycol; poly-ε-caprolactone-modified polyols; polymethyl valerolactone-modified polyols; alkylpolyols such as ethyleneglycol, propyleneglycol, 1,4-butanediol, 1,6-hexanediol and neopentylglycol; bisphenol A skeleton alkylene oxide-modified polyols such as bisphenol A added with ethylene oxide and bisphenol A added with propylene oxide; and urethane(meth)acrylate oligomers prepared from bisphenol F skeleton alkylene oxide-modified polyols such as bisphenol F added with ethylene oxide, bisphenol F added with propylene oxide, or combinations thereof, organic polyisocyanates such as tolylene diisocyanate, isophorone diisocyanate, hexamethylene diisocyanate, diphenylmethane diisocyanate and xylylene diisocyanate, and hydroxyl group-containing (meth)acrylates such as 2-hydroxyethyl(meth)acrylate and 2-hydroxypropyl(meth)acrylate.

Examples of the commercially available urethane(meth)acrylate monomers are Aronix M120, M-150, M-156, M-215, M-220, M-225, M-240, M-245, M-270 (by Toagosei Co.), AIB, TBA, LA, LTA, STA, Viscoat #155, IBXA, Viscoat #158, #190, #150, #320, HEA, HPA, Viscoat #2000, #2100, DMA, Viscoat #195, #230, #260, #215, #335HP, #310HP, #310HG, #312 (by Osaka Organic Chemical Industry Co.), Light Acrylate IAA, L-A, S-A, BO-A, EC-A, MTG-A, DMP-A, THF-A, IB-XA, HOA, HOP-A, HOA-MPL, HOA-MPE, Light Acrylate 3EG-A, 4EG-A, 9EG-A, NP-A, 1,6HX-A, DCP-A (Kyoeisha Chemical Co.), KAYARADTC-110S, HDDA, NPGDA, TPGDA, PEG400DA, MANDA, HX-220, HX-620 (by Nippon Kayaku Co.), FA-611A, 512A, 513A (by Hitachi Chemical Co.), VP (by BASF Co.), ACMO, DMAA, DMAPAA (by Kohjin Co.).

The urethane(meth)acrylate oligomer may be prepared by reaction of (a) hydroxyl group-containing (meth)acrylate, (b) organic polyisocyanate, and (c) polyol; preferably, the oligomer is prepared by reaction of (a) hydroxyl group-containing (meth)acrylate and (b) organic polyisocyanate, followed by (c) polyol.

Examples of the optical radical polymerization initiator include acetophenone, acetophenone benzylketal, 1-hydroxycyclohexyl phenyl ketone, 2,2-dimethoxy-2-phenylacetophenone, xanthone, fluorenone, benzaldehyde, fluorine, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, 2,4,6-trimethylbenzoyl diphenylphosphine oxide, bis-(2,6-dimethoxybenzoyl)-2,4,4-trimethylpentyl phosphine oxide, and ethyl-2,4,6-trimethylbenzoylethoxy phenylphosphine oxide.

Examples of the commercially available photo radical polymerization are Irgacure 184, 369, 651, 500, 819, 907, 784, 2959, CGI1700, CGI1750, CGI11850, CG24-61, Darocur 1116, 1173 (by Ciba Specialty Chemicals Co.), Lucirin LR8728, 8893X (by BASF Co.), Ubecryl P36 (by UCB Co.), KIP150 (by Lamberti Co.). Among these, Lucirin LR8893X is preferable in view of liquid, soluble, and high sensitivity.

The content of the photo radical polymerization initiator is preferably 0.01 to 10% by mass based on the entire composition of the resin, more preferably 0.5 to 7% by mass. In cases where the content is above 10% by mass, curing properties of the composition, mechanical and optical properties of the cured product, and handling properties may be lower, and in cases where the content is below 0.01% by mass, the curing velocity may be lower.

The composition to form the resin may further include a photosensitizer. Examples of the photosensitizer include triethylamine, diethylamine, N-methyldiethanol amine, ethanol amine, 4-dimethylaminobenzoic acid, 4-dimethylaminomethyl benzoate, 4-dimethylaminoethyl benzoate, 4-dimethylaminoisoamyl benzoate, etc.

Examples of the commercially available photosensitizer are Ubecryl P102, 103, 104, 105 (by UCB Co.).

The composition may further include, in addition to the ingredients described above, various additives such as antioxidants, UV absorbers, light stabilizers, silane coupling agents, coated-surface improvers, thermal polymerization inhibitors, leveling agents, surfactants, colorants, storage stabilizers, plasticizers, lubricants, solvents, fillers, age resistors, wettability improvers, and releasing agents, as required.

Examples of the antioxidants include Irganox 1010, 1035, 1076, 1222 (by Ciba Specialty Chemicals Co.) and Antigen P, 3C, FR, GA-80 (by Sumitomo Chemical Co.).

Examples of the UV absorbers include Tinuvin P, 234, 320, 326, 327, 328, 329, 213 (by Ciba Specialty Chemicals Co.) and Seesorb 102, 103, 110, 501, 202, 712, 704 (by Shipro Kasei Kaisha, Ltd.).

Examples of the light stabilizers include Tinuvin 292, 144, 622LD (by Ciba Specialty Chemicals Co.), Sanol LS770 (by Daiichi-Sankyo Co.), and Sumisorb TM-061 (by Sumitomo Chemical Co.).

Examples of the silane coupling agents include gamma-aminopropyltriethoxysilane, gamma-mercaptopropyltrimethoxysilane, gamma-methacryloxypropyltrimethoxysilane, and also commercially available articles such as SH6062, 6030 (by Dow Corning Toray Co.) and KBE903, 603, 403 (by Shin-Etsu Chemical Co.).

Examples of the coated-surface improvers include silicone additives such as dimethylsiloxane polyether and nonionic fluorosurfactants.

Examples of commercially available silicone additives described above include DC-57, DC-190 (by Dow Corning Co.), SH-28PA, SH-29PA, SH-30PA, SH-190 (by Dow Corning Toray Co.), KF351, KF352, KF353, KF354 (by Shin-Etsu Chemical Co.), and L-700, L-7002, L-7500, FK-024-90 (by NIppon Unicar Co.), examples of commercially available nonionic fluorosurfactants include FC-430, FC-171 (by 3M Co.), and Megafac F-176, F-177, R-08 (Dainippon Ink & Chemicals, Inc.).

Examples of the releasing agent include Plysurf A208F (by Dai-ichi Kogyo Seiyaku Co.).

The organic solvent, which being employed to adjust the viscosity of the resin liquid, may be anything as long as capable of mixing without nonuniformity such as deposition, phase-separation, and white turbidity when being mixed with the resin liquid; examples of the organic solvent include acetone, methylethylketone, methylisobutylketone, ethanol, propanol, butanol, 2-methoxyethanol, cyclohexanol, cyclohexane, cyclohexanone, and toluene. These may be used alone or in combination of two or more.

In cases where the organic solvent is added, a step is necessary to dry and/or evaporate the organic solvent. When the organic solvent remains in a considerable amount within products, there may arise such problems that mechanical properties are poor or the organic solvent evaporates and diffuses to generate foul smell or adversely affect human health in use as products. Therefore, organic solvents having a high boiling point are undesirable due to higher residual amount of the organic solvents. On the other hand, organic solvents having an unduly low boiling point result in violent evaporation, consequently, the surface condition may be roughened, water maybe condensed and deposited on the surface of the composition due to vaporization heat at drying and the traces may lead to planar defects, or higher vapor concentration increases the risk to catch fire.

Accordingly, the boiling point of the organic solvent is preferably 50° C. to 150° C., more preferably 70° C. to 120° C. Specifically, the organic solvent is preferably methylethylketone (boiling point: 79.6° C.), 1-propanol (boiling point: 97.2° C.), or the like.

The content of the organic solvent, added to the resin liquid, depends on the species of the organic solvent and viscosity of the resin liquid before the addition of the organic solvent; preferably, the content is typically 10 to 40% by mass, preferably 15 to 30% by mass in order to sufficiently improve the coating ability. When the content is less than 10% by mass, the improvement of the coating ability may be insufficient such that the effect to reduce the viscosity or to increase the coating amount is insignificant. On the other hand, when the content is above 40% by mass, there may arise such problems as the coating is nonuniform since the liquid easily flows on the sheet due to excessively low viscosity or the liquid turns around the backside of the sheet. In addition, the organic solvent may remain in a considerable amount within products due to insufficient drying in the drying step, there may therefore arise such problems that the products degrade their function or the organic solvent evaporates to generate foul smell or adversely affect human health in use as products.

The resin liquid can be produced by conventional processes to mix and solve the ingredients while heating as required.

The viscosity of the resin liquid, produced as described above, is typically 10 to 50,000 mPa·s at 25° C. When the viscosity is excessively high, it is difficult to supply the composition of the resin liquid uniformly to substrates or emboss rolls, thus unevenness of the coating, wave, or inclusion of babbles tends to occur in the production processes of lenses, and it is difficult to take an intended thickness of lenses and to generate sufficient performances of lenses, which is significant under a higher line speed. Therefore, the viscosity of the resin liquid, which being desirably lowered in such cases, is preferably 10 to 100 mPa·s, more preferably 10 to 50 mPa·s. The lower viscosity may be attained by way of adding an adequate amount of the organic solvent or setting the temperature of the coating liquid within an appropriate range.

On the other hand, when the viscosity is excessively low, it may be difficult to control the lens thickness and to produce lenses with a constant thickness in the mold-pressing processes by the emboss roll. The viscosity, which being desirably raised in such cases, is preferably 100 to 3000 mPa·s.

In cases where the organic solvent being mixed, when a step to evaporate the organic solvent by heating and drying is provided between the step of feeding the resin liquid to the step of mold-pressing by the emboss roll, the resin liquid may be uniformly fed under a lower viscosity at the step of feeding, and the resin liquid with a higher viscosity after drying the organic solvent may be mold-pressed uniformly at step of mold-pressing by the emboss roll.

The cured material, which being produced by irradiating a radiation to the resin liquid, has preferably a refractive index of 1.55 or more at 25° C., more preferably 1.56 or more. When the refractive index is below 1.55, it may be impossible to assure sufficiently the front brightness for the optical functional sheet.

### Other Member

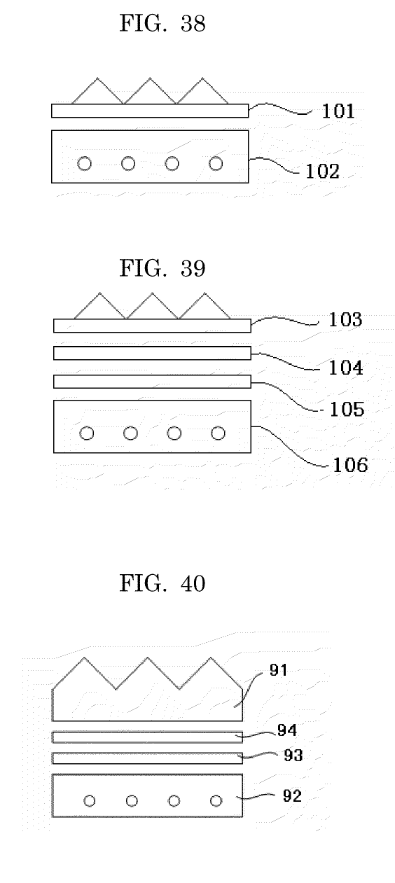

The backlight unit may be equipped with other members as requires. The other member is exemplified by a reflective plate, a diffusing plate, or a diffusing sheet (FIGS. 38, 39). The backlight unit, shown in FIG. 38, is equipped with an optical functional sheet 101 and a light box 102 of which the bottom face and the side face at inside are attached with a reflective plate. The backlight unit, shown in FIG. 39, is equipped with an optical functional sheet 103, a diffusing sheet(s) 104, a diffusing plate 105, and a light box 106 of which the bottom face and the side face at inside are attached with a reflective plate.

The prisms may be formed on the diffusible functional members such as the diffusing plate and the diffusing sheet; thereby, the optical functional sheet and the diffusible functional member can be integrated and the production cost can be reduced. The prisms may be either at the side of the linear light source or at the opposite side of the linear light source on the diffusible functional member.

### Positional Relation Between Linear Light Source and Optical Functional Sheet in First Embodiment

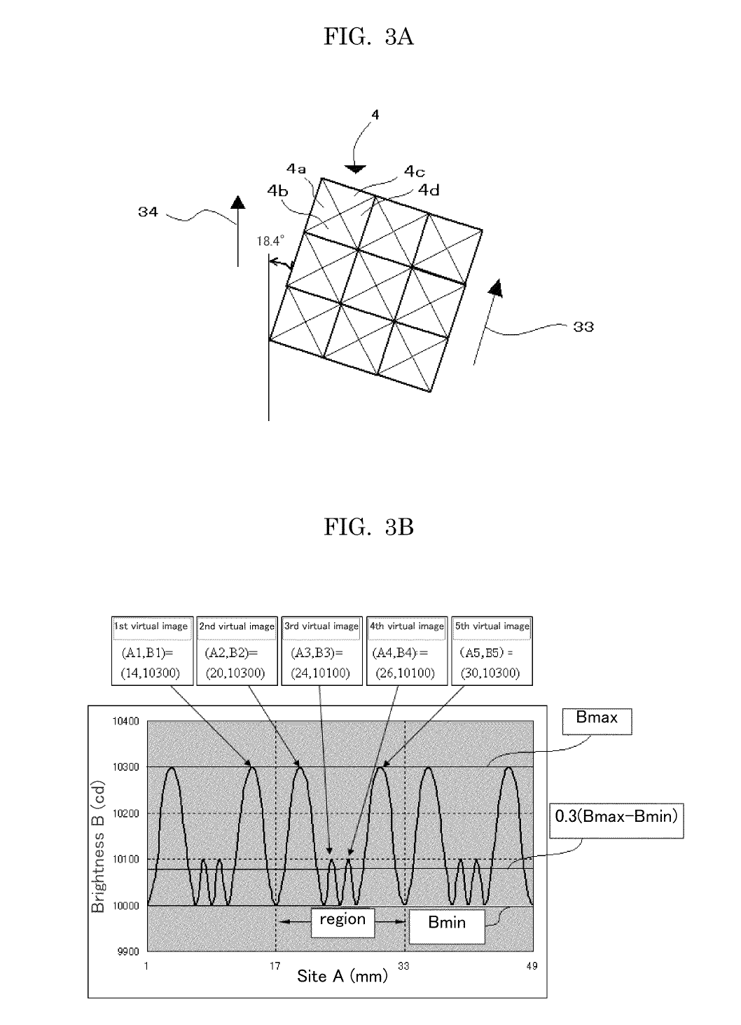

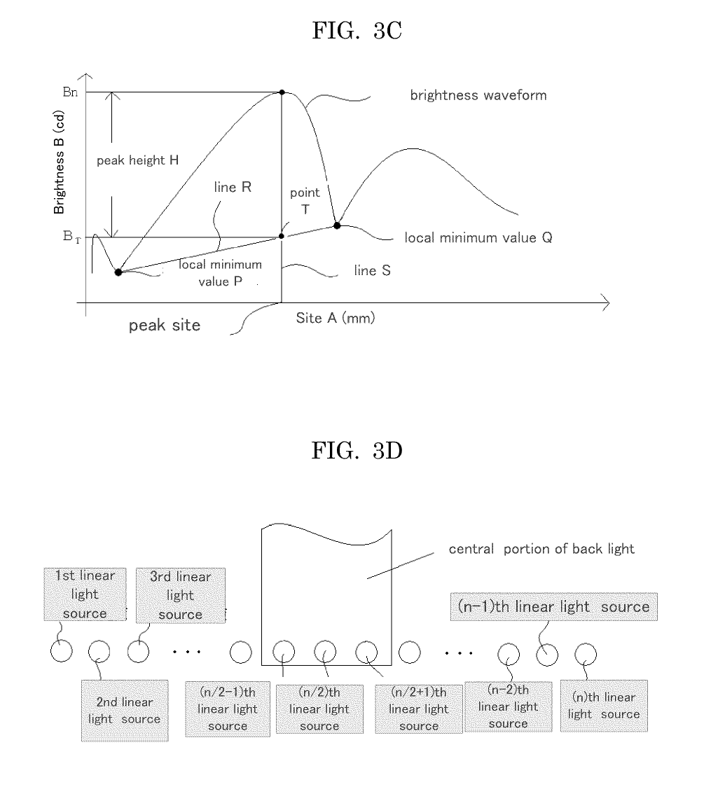

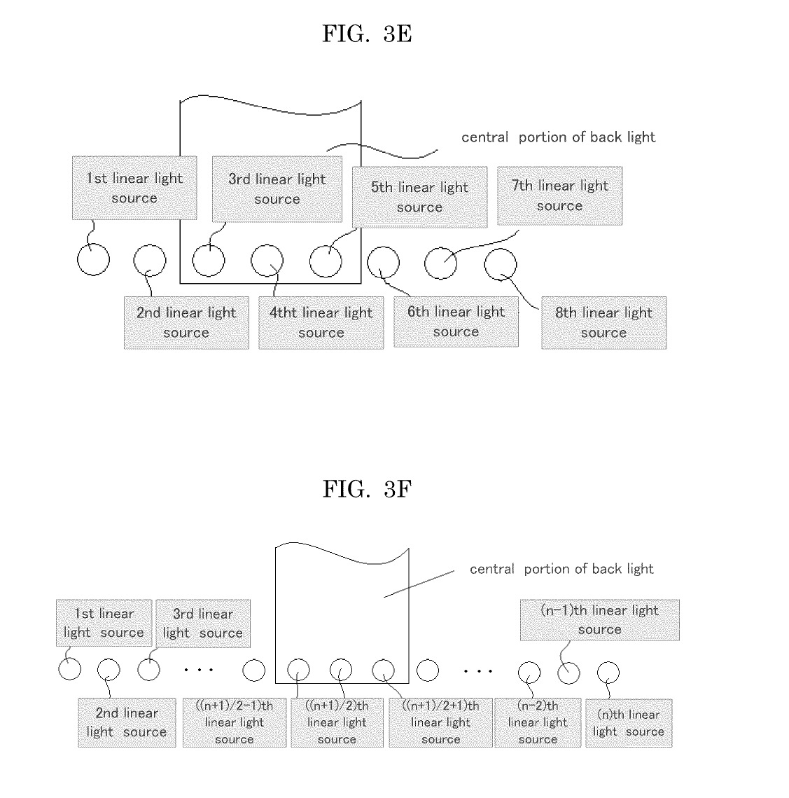

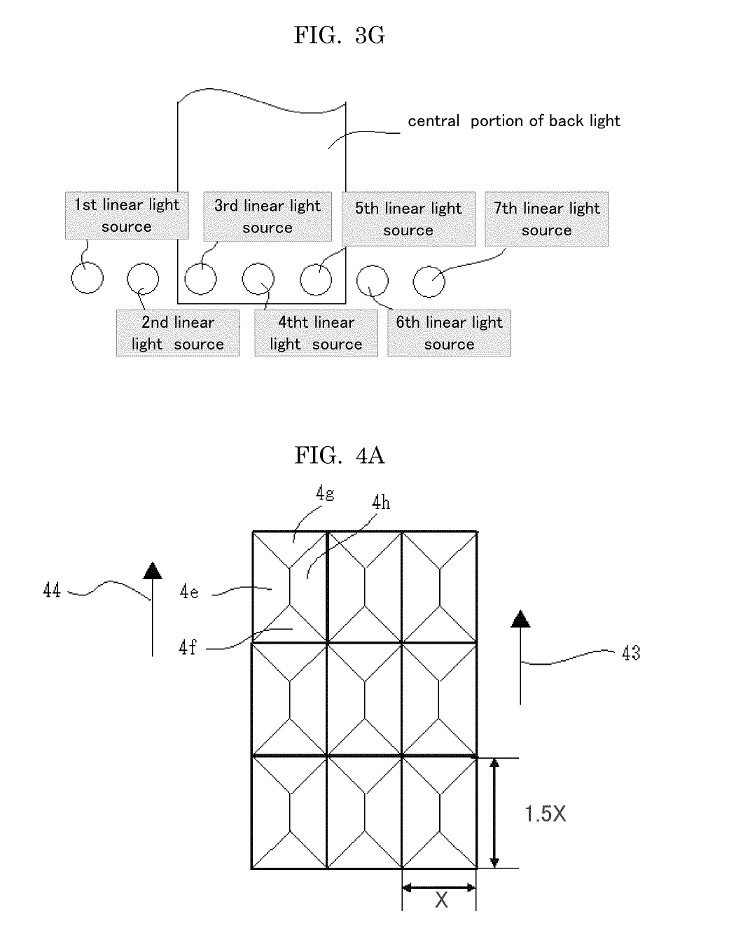

In cases where the shape of prisms 4 of the optical functional sheet 1 is a regular four-sided pyramid of concave or convex, as shown in FIG. 3A, the aligning direction (arrow 33) of the prisms 4 is inclined against the direction (arrow 34) of the linear light source at an angle of 18.4° (=tan⁻¹ ⅓), which being theoretically most desirable, so that the brightnesses of virtual images derived from a linear light source are approximately the same over the optical functional sheet 1 and the distances of adjacent virtual images derived from a linear light source are approximately the same over the optical functional sheet 1, and thus the brightnesses of virtual images derived from plural linear light sources are approximately the same over the optical functional sheet 1 and the distances of adjacent virtual images derived from plural linear light sources are approximately the same over the optical functional sheet 1. Consequently, the light diffusing function may be enhanced without degrading the light condensing function and also the unevenness of linear light source may be mitigated. When the aligning direction (arrow 33) of the prisms 4 is not inclined against the direction (arrow 34) of the linear light source, the brightness of the virtual image at the central site of the optical functional sheet 1 comes to two times of the brightness of other two sites.

FIG. 3A shows the case that the inclination angle is 18.4° between the aligning direction (arrow 33) of the prisms 4 and the direction (arrow 34) of the linear light source; the inclination angle, which being not limited to the value, is appropriately arranged depending on the arrangement or species of the diffusing sheet, diffusing plate, or reflecting plate, and the distance between the linear light sources and the optical functional sheet 1, etc.

In cases where the shape of prisms 4 of the optical functional sheet 1 is a regular four-sided pyramid of concave or convex, the brightnesses are equivalent between the case that the aligning direction (arrow 33) of the prisms 4 is inclined against the direction (arrow 34) of the linear light source at an angle of X° and the case that is inclined at an angle of (90−X)°.

When the brightnesses of the virtual images derived from plural linear optical lights are not constant for the optical functional sheet 1, it is desirable that the distances between the adjacent virtual images are appropriately changed depending on the brightnesses of the virtual images. Specifically, as shown in FIG. 3B, the distances between the adjacent virtual images are appropriately changed such that the values of (H₁+H₂)/(A₂−A₁), (H₂+H₃)/(A₃−A₂), (H₃+H₄)/(A₄−A₃), and (H₄+H₅)/(A₅−A₄) come to approximately equivalent; in which Bmax: maximum brightness at the central portion of the backlight unit in the optical functional sheet 1, Bmin: minimum brightness, A₁: peak site of a first virtual image among plural virtual images derived from plural linear light sources 30 in the optical functional sheet 1, peak height: H₁ (peak brightness B₁−minimum brightness Bmin), A₂: peak site of a second virtual image adjacent to the first virtual image, peak height: H₂ (peak brightness B₂−minimum brightness Bmin), A₃: peak site of a third virtual image adjacent to the second virtual image, peak height: H₃ (peak brightness B₃−minimum brightness Bmin), A₄: peak site of a fourth virtual image adjacent to the third virtual image, peak height: H₄ (peak brightness B₄−minimum brightness Bmin), A₅: peak site of a fifth virtual image adjacent to the forth virtual image, peak height: H₅ (peak brightness B₅−minimum brightness Bmin).

In this description, the virtual image corresponds to a peak of which the peak height Hn satisfies the condition of Hn≧0.3×(Bmax−Bmin). In the graph of brightness distribution shown in FIG. 3B, the brightness distribution of an optical functional sheet is shown in which the backlight unit is equipped with neither the diffusing sheet nor the diffusing plate.

The results, calculated based on the values indicated in FIG. 3B, are shown in the following.

(H₁+H₂)/(A₂−A₁)=(300+300)/6=100

(H₂+H₃)/(A₃−A₂)=(300+100)/4=100

(H₃+H₄)/(A₄−A₃)=(100+100)/2=100

(H₄+H₅)/(A₅−A₄)=(100+300)/4=100

The values (=100) of (H₁+H₂)/(A₂−A₁), (H₂+H₃)/(A₃−A₂), (H₃+H₄)/(A₄−A₃), and (H₄+H₅)/(A₅−A₄) are preferably as small as possible.

In this regard, the ratios of the sum of peak heights (Hₙ₋₁+Hₙ) of the adjacent virtual images, i.e. (n−1)th virtual image and (n)th virtual image, to the distance (Aₙ−Aₙ₋₁) between peek sites of the adjacent virtual images are made approximately equivalent at the central portion of the backlight unit, since the peak site and the brightness come to indefinite at edge portions of the backlight unit due to shading effect.

Although the peak height Hₙ is calculated as (peak brightness Bₙ−minimum brightness Bmin) since local minimum values of the brightness wave patterns are entirely a constant value (minimum brightness Bmin), as shown in FIG. 3B, the peak height H is calculated as (peak brightness Bₙ−brightness B_{T}) when the local minimum values of the brightness wave patterns are valuable as shown in FIG. 3C. In this relation, B_{T} is a brightness at an intersection point T of straight line R (line that connects a local minimum value P of the starting point of the peak and a local minimum value Q of the ending point of the peak) and straight line S (perpendicular line that passes a peak site).

The central portion of backlight will be explained in the following.

In cases where the number of plural linear light sources is “n” (even number) as shown in FIG. 3D, the central portion of backlight is defined as the area that contains three linear light sources of the (n/2−1)th, the (n/2)th, and the (n/2+1)th linear light sources, in which the linear light source of leftmost edge is the first linear light source, the linear light source adjacent to the first linear light source is the second linear light source, . . . , the linear light source adjacent to the (n−2)th linear light source is the (n−1)th linear light source, and the linear light source adjacent to the (n−1)th linear light source is the (n)th linear light source. For example, when the number of plural linear light sources is eight as shown in FIG. 3E, the area including the third, the fourth, and the fifth linear light sources is defined the central portion of backlight.

In cases where the number of plural linear light sources is “n” (odd number) as shown in FIG. 3F, the central portion of backlight is defined as the area that includes three linear light sources of the ((n+1)/2−1)th, the ((n+1)/2)th, and the ((n+1)/2+1)th linear light sources, in which the linear light source of leftmost edge is the first linear light source, the linear light source adjacent to the first linear light source is the second linear light source, . . . , the linear light source adjacent to the (n−2)th linear light source is the (n−1)th linear light source, and the linear light source adjacent to the (n−1)th linear light source is the (n)th linear light source. For example, when the number of plural linear light sources is seven as shown in FIG. 3G, the area including the third, the fourth, and the fifth linear light sources is the central portion of backlight.

In a case that the shape of prisms 4 of the optical functional sheet 1 is concave or convex semi-four-sided pyramid, as shown in FIG. 4A, in which aspect ratio is 1.5 (bottom face: 50 μm by 75 μm, height: 25 μm) and the top of pyramid is linear, brightnesses of three virtual images derived from a linear light source are approximately equivalent for the optical functional sheet 1, when the aligning direction (arrow 43) of the prisms 4 is not inclined against the direction (arrow 44) of the linear light source, since the area ratio of light-emitting faces 4e, 4f, 4g, and 4h of the linear light source is 2:1:1:2 in the prisms 4.

In some cases, the unevenness of linear light sources is lower when the aligning direction (arrow 43) of the prisms 4 is inclined against the direction (arrow 44) of the linear light source (FIG. 4C) rather than when the aligning direction (arrow 43) of the prisms 4 is not inclined against the direction (arrow 44) of the linear light source (FIG. 4B), by way that the virtual images derived from a linear light source for the optical functional sheet 1 are overlapped by virtual images derived from another linear light source for the optical functional sheet 1.

The aspect ratio is not limited to 1.5 in terms of the bottom face of the shape as regards the prism 4 of the optical functional sheet 1, but is allowable for the range of 1.0 to 5.0.

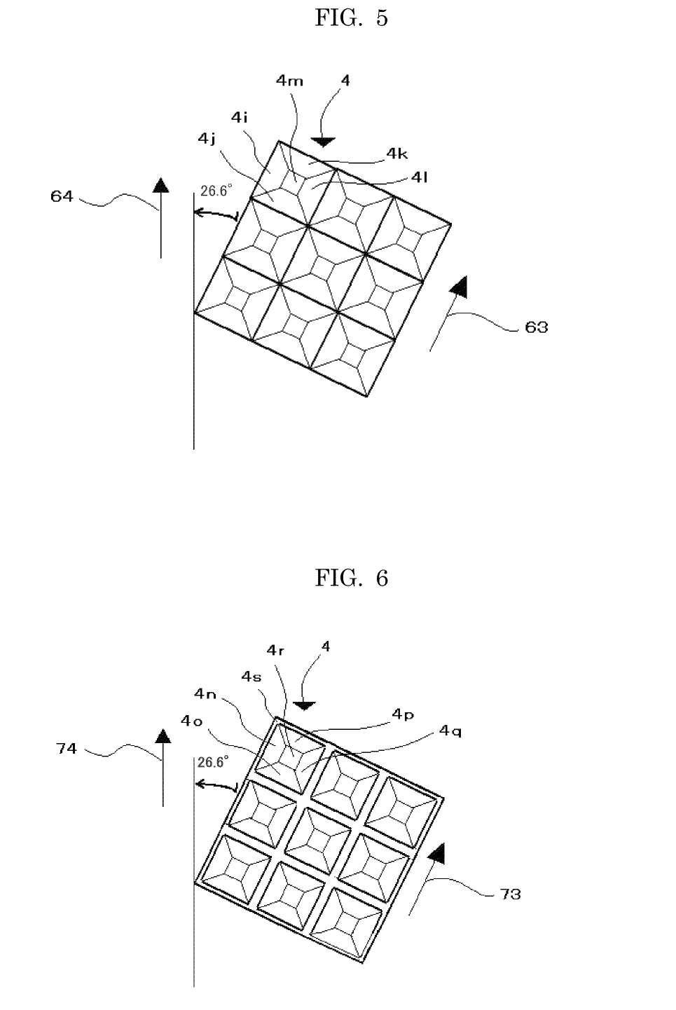

Furthermore, in cases where the shape of prisms 4 of the optical functional sheet 1 is a four-sided truncated pyramid of concave or convex, as shown in FIG. 5, the aligning direction (arrow 63) of the prisms 4 is inclined against the direction (arrow 64) of the linear light source at an angle of 26.6° (=tan⁻¹ ½), which being theoretically most desirable, so that the brightnesses of virtual images derived from a linear light source are approximately the same over the optical functional sheet 1 and the distances of adjacent virtual images derived from a linear light source are approximately the same over the optical functional sheet 1, and thus the brightnesses of virtual images derived from plural linear light sources are approximately the same over the optical functional sheet 1 and the distances of adjacent virtual images derived from plural linear light sources are approximately the same over the optical functional sheet 1. Consequently, the light diffusing function may be enhanced without degrading the light condensing function and also the unevenness of linear light source may be mitigated.

FIG. 5 shows the case that the inclination angle is 26.6° between the aligning direction (arrow 63) of the prisms 4 and the direction (arrow 64) of the linear light source; the inclination angle, which being not limited to the value, is appropriately arranged depending on the arrangement or species of the diffusing sheet, diffusing plate, or reflecting plate, and the distance between the linear light sources and the optical functional sheet, etc.

As regards the areas of the emitting faces 4i, 4j, 4k, 4l, and 4m, it is preferred that the ratio of the area of the emitting face 4i to the area of the emitting face 4m (area of emitting face 4i/area of emitting face 4m) is arranged to be 0.25 to 4, more preferably the areas of the emitting faces 4i, 4j, 4k, 4l, and 4m are equivalent.

The shape of the prisms is not limited to the four-sided pyramid of which the top is flat (truncated pyramid) as shown in FIG. 5, rather the top of the pyramid may be rounded thereby to improve the light diffusing function.

Furthermore, in cases where the shape of prisms 4 of the optical functional sheet 1 is a semi-four-sided truncated pyramid of concave or convex (space between truncated pyramids), as shown in FIG. 6, the aligning direction (arrow 73) of the prisms 4 is inclined against the direction (arrow 74) of the linear light source at an angle of 26.6° (=tan⁻¹ ½), which being theoretically most desirable, so that the brightnesses of virtual images derived from a linear light source are approximately the same over the optical functional sheet 1 and the distances of adjacent virtual images derived from a linear light source are approximately the same over the optical functional sheet 1, and thus the brightnesses of virtual images derived from plural linear light sources are approximately the same over the optical functional sheet 1 and the distances of adjacent virtual images derived from plural linear light sources are approximately the same over the optical functional sheet 1. Consequently, the light diffusing function may be enhanced without degrading the light condensing function and also the unevenness of linear light source may be mitigated.

FIG. 6 shows the case that the inclination angle is 26.6° between the aligning direction (arrow 73) of the prisms 4 and the direction (arrow 74) of the linear light source; the inclination angle, which being not limited to the value, is appropriately arranged depending on the arrangement or species of the diffusing sheet, diffusing plate, or reflecting plate, and the distance between the linear light source and the optical functional sheet 1, etc.

The shape of the prisms is not limited to the four-sided pyramid of which the top is flat (semi-four-sided truncated pyramid) as shown in FIG. 6, rather the top of the pyramid may be rounded thereby to improve the light diffusing function.

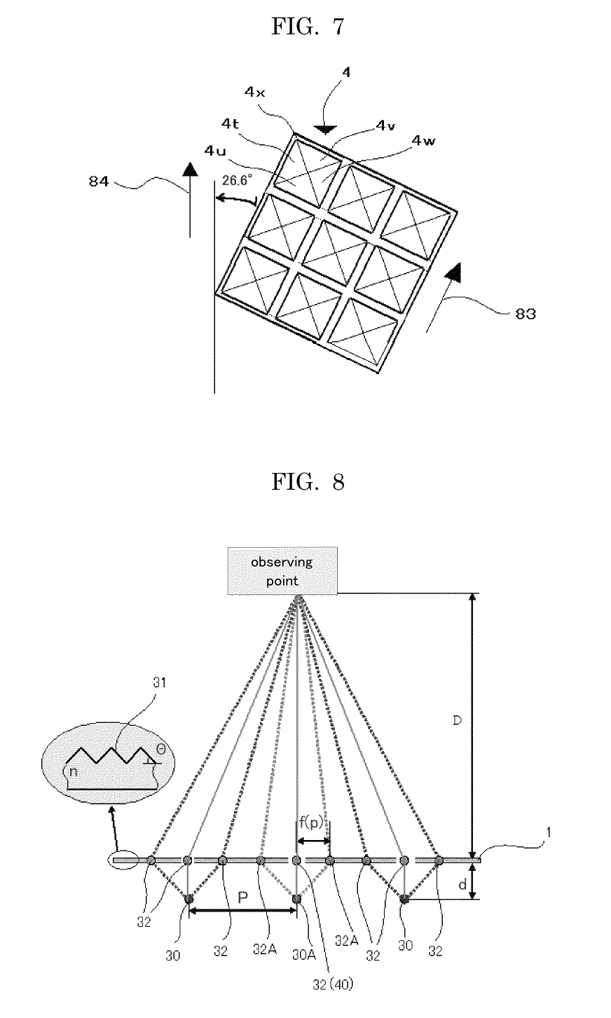

Furthermore, in cases where the shape of prisms 4 of the optical functional sheet 1 is a semi-four-sided pyramid of concave or convex (space between pyramids), as shown in FIG. 7, the aligning direction (arrow 83) of the prisms 4 is inclined against the direction (arrow 84) of the linear light source at an angle of 26.6° (=tan⁻¹ ½), which being theoretically most desirable, so that the brightnesses of virtual images derived from a linear light source are approximately the same over the optical functional sheet 1 and the distances of adjacent virtual images derived from a linear light source are approximately the same over the optical functional sheet 1, and thus the brightnesses of virtual images derived from plural linear light sources are approximately the same over the optical functional sheet 1 and the distances of adjacent virtual images derived from plural linear light sources are approximately the same over the optical functional sheet 1. Consequently, the light diffusing function may be enhanced without degrading the light condensing function and also the unevenness of linear light source may be mitigated.

FIG. 7 shows the case that the inclination angle is 26.6° between the aligning direction (arrow 83) of the prisms 4 and the direction (arrow 84) of the linear light source; the inclination angle, which being not limited to the value, is appropriately arranged depending on the arrangement or species of the diffusing sheet, diffusing plate, or reflecting plate, and the distance between the linear light source and the optical functional sheet 1, etc.

The inventive concept described above can be applied where the shape of prisms 4 of the optical functional sheet 1 is formed by concave or convex V-shaped grooves.

It is theoretically preferred that the optical functional sheet is arranged such that two prism sheets are overlapped to be orthogonal between the directions of V-shaped grooves and one prism sheet, facing the linear light source, is placed such that the angle between the direction of V-shaped grooves and the aligning direction of a cold cathode tube is 26.6° (=tan⁻¹ ½).

In cases where the two prism sheets are overlapped orthogonally between the directions of V-shaped grooves, the results are equivalent between the case that the angle between the direction of V-shaped grooves of one prism sheet (facing the linear light source) and the aligning direction of a cold cathode tube is X° and the case that the angle is (90−X)°.

It is also preferred that the apex angle of the prism shape formed by V-shaped grooves is arranged to be 60° to 120°.

When the light source is not linear but point-like, the direction of fictive line that connects the point-like light sources is considered as the aligning direction of the linear light source.

In order to enhance the productivity or the diffusing ability, the top portion of prisms 4 may be flatted or rounded, or the bevel angle θ of prisms 4 (angle of emitting face against reference face 3b) may be reduced. From the viewpoint of light condensing property, the bevel angle θ is preferably 40° to 50°, more preferably 44° to 46°. When the productivity or the diffusing ability should be enhanced even though the light condensing property is decreased, the bevel angle θ is preferably no more than 45° in order to suppress the sidelobe.

The light diffusing function and the light condensing function may also be enhanced by way of incorporating diffusive particles into all of or a part of the optical functional sheet 1.

The odd number of emitting faces of the prisms 4 is undesirable since the angle (apex angle) between opposed emitting faces is other than 90° and thus the light condensing property is lowered.

When the prisms 4 are of a regular six-sided pyramid, a similar effect to mitigate unevenness may be expected since six virtual images can generate although the virtual images do not appear with an equal space.

It is difficult to produce the prisms 4 of regular seven-sided or more pyramid since the prisms cannot be placed with no gap.

The diffusing ability can also be enhanced by way of somewhat decreasing the bevel angle θ along with going out from center to edge of the optical functional sheet 1 (e.g., 47° at center, 43° at edge). The diffusing ability can also be enhanced by way of somewhat widening the pitch of the linear light sources 30 along with going out from center of the optical functional sheet 1.

### Positional Relation Between Linear Light Source and Optical Functional Sheet in Second Embodiment

FIG. 8 is a view that explains a positional relation between the optical functional sheet shown in FIG. 1 and linear light sources.

In the positional relation of the optical functional sheet 1 and the linear light source 30 shown in FIG. 8, f(p) is a distance between a nodal line 40 and a virtual image that is nearest to the nodal line; in which the nodal line is one between a flat surface, which containing a linear light source (e.g., linear light source 30A) among the plural linear light sources and being perpendicular to the optical functional sheet 1, and a flat surface, which containing the optical functional sheet 1, and the nodal line is a projected line 40 of a linear light source (e.g., linear light source 30A) among the plural linear light sources onto the optical functional sheet 1; and the virtual image is one (e.g., virtual image 32A) that is nearest to the nodal line 40 except for ones on the nodal line 40 among the virtual images of the optical functional sheet 1 derived from a linear light source (e.g., linear light source 30A). The f(p) is virtually determined, as Equation (1) below, by refractive index “n” of optical functional sheet 1, bevel angle (cross-section angle) θ of emitting face 31 of prisms 4, distance “d” between linear light sources 30 and optical functional sheet 1 (distance “d” between the center of linear light sources 30 and the bottom portion of prism 4 (fine shape) of optical functional sheet 1), and distance D between optical functional sheet 1 and observing point. In this regard, f(p) may have an error of no less than ±1 mm, when being outside the condition of d=0 to 30 mm, n=1.5 to 1.7, θ=40° to 50°, and D=250 mm or less.

f(p)=0.557d+27.9n+0.473θ−65.7 Equation (1)

The virtual image 32, derived from the linear light source 30, on the optical functional sheet 1 is one that generates at a site other than the actual site of the linear light source 30, when the linear light source 30 is viewed from the observing point through the optical functional sheet 1.

Accordingly, the diffusing ability may be enhanced by selecting the distance “d” so as to take the most appropriate virtual image distribution depending on the pitch “p” of the linear light sources 30 (when the brightnesses of virtual images 32, derived from the linear light source 30, on the optical functional sheet 1 is approximately equivalent, the distances between adjacent virtual images are approximately the same). Since the bevel angle (cross-section angle) θ is an angle of geometrical cross-section of prisms 4, the diffusing level can be adjusted by rotating the optical functional sheet 1 without affecting the light condensing property.

In addition, when the brightnesses of the virtual images 32 derived from plural linear optical lights 30 are not constant for the optical functional sheet 1, it is desirable that the distances between the adjacent virtual images 32 are appropriately changed depending on the brightnesses of the virtual images 32. Specifically, as shown in FIG. 3B, the distance “d” between the linear light sources 30 and the optical functional sheet 1 is appropriately selected such that the values of (H₁+H₂)/(A₂−A₁), (H₂+H₃)/(A₃−A₂), (H₃+H₄)/(A₄−A₃), and (H₄+H₅)/(A₅−A₄) come to approximately equivalent; in which Bmax: maximum brightness at the central portion of the backlight unit in the optical functional sheet 1, Bmin: minimum brightness, A₁: peak site of a first virtual image among plural virtual images 32 derived from plural linear light sources 30 in the optical functional sheet 1, peak height: H₁ (peak brightness B₁−minimum brightness Bmin), A₂: peak site of a second virtual image adjacent to the first virtual image, peak height: H₂ (peak brightness B₂−minimum brightness Bmin), A₃: peak site of a third virtual image adjacent to the second virtual image, peak height: H₃ (peak brightness B₃−minimum brightness Bmin), A₄: peak site of a fourth virtual image adjacent to the third virtual image, peak height: H₄ (peak brightness B₄−minimum brightness Bmin), A₅: peak site of a fifth virtual image adjacent to the forth virtual image, peak height: H₅ (peak brightness B₅−minimum brightness Bmin).

In this description, the virtual image 32 corresponds to a peak of which the peak height Hn satisfies the condition of Hn≧0.3×(Bmax−Bmin). In the graph of brightness distribution shown in FIG. 3B, the brightness distribution of an optical functional sheet is shown in which the backlight unit is equipped with neither the diffusing sheet nor the diffusing plate.

The results, calculated based on the values shown in FIG. 3B, are shown in the following.

(H₁+H₂)/(A₂−A₁)=(300+300)/6=100

(H₂+H₃)/(A₃−A₂)=(300+100)/4=100

(H₃+H₄)/(A₄−A₃)=(100+100)/2=100

(H₄+H₅)/(A₅−A₄)=(100+300)/4=100

The values (=100) of (H₁+H₂)/(A₂−A₁), (H₂+H₃)/(A₃−A₂), (H₃+H₄)/(A₄−A₃), and (H₄+H₅)/(A₅−A₄) are preferably as small as possible.

In this regard, the ratios of the sum of peak heights (Hₙ₋₁+Hₙ) of the adjacent virtual images, i.e. (n−1)th virtual image and (n)th virtual image, to the distance (Aₙ−Aₙ₋₁) between peek sites of the adjacent virtual images are made approximately equivalent at the central portion of the backlight unit, since the peak site and the brightness come to indefinite at edge portions of the backlight unit due to shading effect.

Although the peak height Hₙ is calculated as (peak brightness Bₙ−minimum brightness Bmin) since local minimum values of the brightness wave patterns are entirely a constant value of the minimum brightness Bmin, as shown in FIG. 3B, the peak height H is calculated as (peak brightness Bₙ−brightness B_{T}) when the local minimum values of the brightness wave patterns are valuable as shown in FIG. 3C. In this relation, B_{T} is a brightness at an intersection point T of straight line R (line that connects a local minimum value P of the starting point of the peak and a local minimum value Q of the ending point of the peak) and straight line S (perpendicular line that passes a peak site).

The central portion of backlight will be explained in the following.

In cases where the number of plural linear light sources is “n” (even number) as shown in FIG. 3D, the central portion of backlight is defined as the area that contains three linear light sources of the (n/2−1)th, the (n/2)th, and the (n/2+1)th linear light sources, in which the linear light source of leftmost edge is the first linear light source, the linear light source adjacent to the first linear light source is the second linear light source, . . . , the linear light source adjacent to the (n−2)th linear light source is the (n−1)th linear light source, and the linear light source adjacent to the (n−1)th linear light source is the (n)th linear light source. For example, when the number of plural linear light sources is eight as shown in FIG. 3E, the area including the third, the fourth, and the fifth linear light sources is the central portion of backlight.

In cases where the number of plural linear light sources is “n” (odd number) as shown in FIG. 3F, the central portion of backlight is defined as the area that contains three linear light sources of the ((n+1)/2−1)th, the ((n+1)/2)th, and the ((n+1)/2+1)th linear light sources, in which the linear light source of leftmost edge is the first linear light source, the linear light source adjacent to the first linear light source is the second linear light source, . . . , the linear light source adjacent to the (n−2)th linear light source is the (n−1)th linear light source, and the linear light source adjacent to the (n−1)th linear light source is the (n)th linear light source. For example, when the number of plural linear light sources is seven as shown in FIG. 3G, the area including the third, the fourth, and the fifth linear light sources is the central portion of backlight.

The virtual images appear in a number same with the number of the emitting faces of the prisms 4, except for overlapped virtual images. Therefore, in cases of monolayer, four-sided pyramid prisms 4 are more preferable than prisms 4 having V-shaped grooves in order to enhance the diffusing ability.

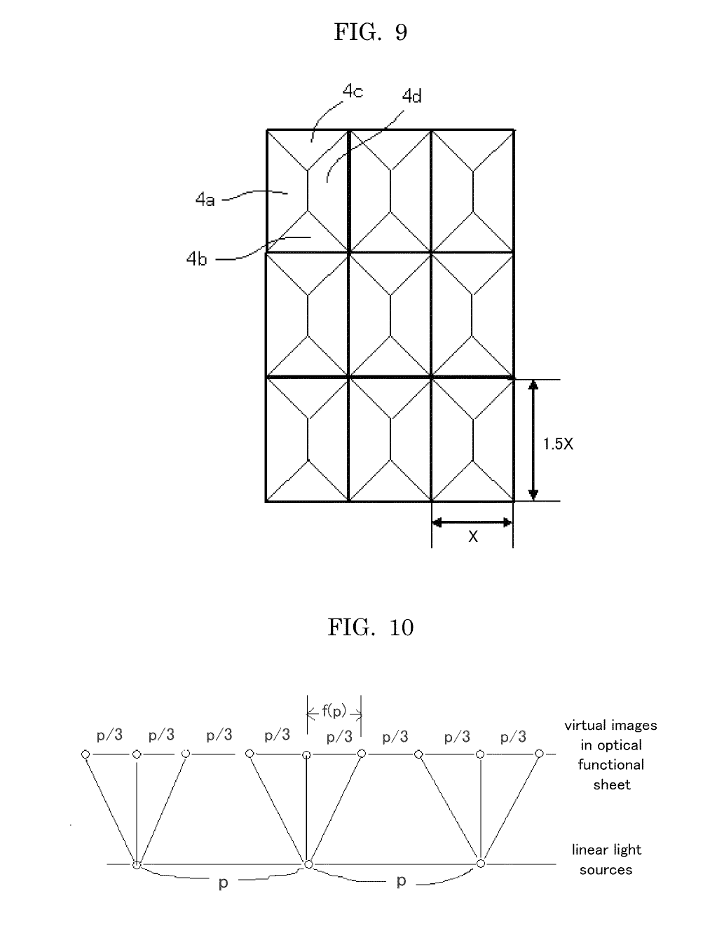

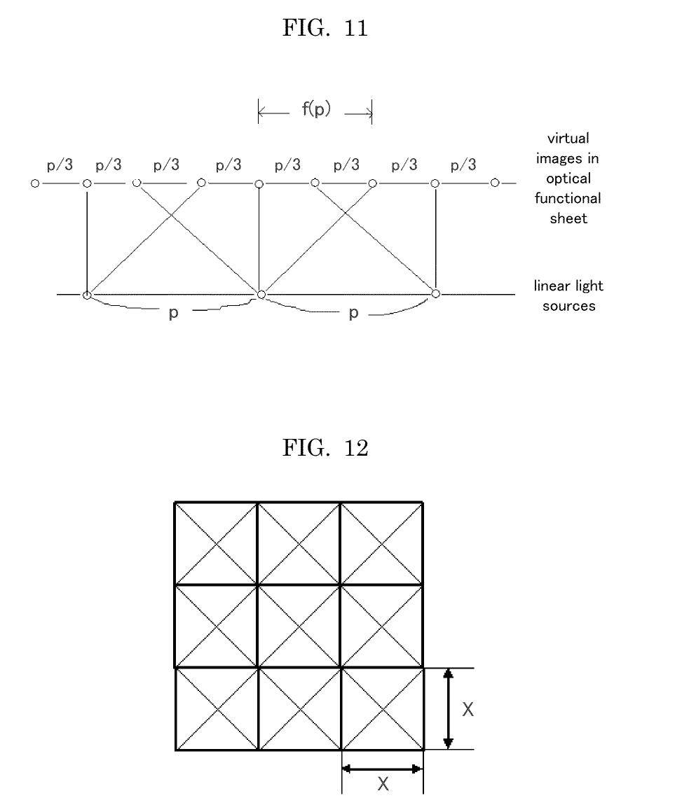

In the case of prisms 4 as shown in FIG. 9, for example, in which each of the prisms 4 has two of the first emitting faces 4b and 4c opposing each other and two of the second emitting faces 4a and 4d opposing each other, sum (S_{4b}+S_{4c}) of the first emitting face areas S_{4b} and S_{4c} is the same with one area of the second emitting face areas S₄ₐ or S_{4d}, and the prism shape is semi-four-sided pyramid with a convex or concave bottom face of an aspect (longitudinal/traverse) ratio AR of 1.5, it is preferred that the aligning direction of the prisms 4 and the orientation direction of the linear light sources be made parallel (inclination angle: 0°) thereby to generate three virtual images from one linear light source (e.g., linear light source 30A) per prism 4, and also the distance “d” between the optical functional sheet 1 and the linear light sources 30 is optimized. Consequently, the diffusing ability may be further enhanced. Under this condition, the brightness unevenness of the linear light sources 30 may be minimized by defining “d”, “n”, and θ of Equation (1) such that f(p)=p/3 (FIG. 10) or f(p)=2×p/3 (FIG. 11). The aspect ratio AR of bottom face is not defined to 1.5, but may be within a range of 1<AR≦5. In this regards, when AR is 1.5, the unevenness can be mitigated by way of equalizing the spaces between the virtual images since three virtual images generate per liner light source, meanwhile, an equal space between the virtual images is not necessarily optimal since the brightnesses of the virtual images are not constant when AR is other than 1.5.

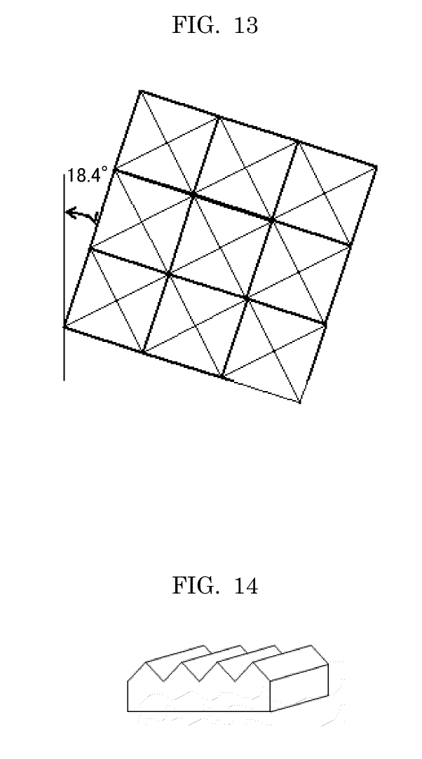

When the prisms 4 are of a concave or convex regular four-sided pyramid with a bottom-face aspect ratio AR of 1.0 as shown in FIG. 12, it is preferred that the aligning direction of the prisms 4 and the linear light source 30 are disposed to make an inclination angle of 18.4° (=tan⁻¹ ⅓) (FIG. 13) thereby to generate four virtual images from one linear light source (e.g., linear light source 30A), and also the distance “d” between the optical functional sheet 1 and the linear light sources 30 is optimized. Under this condition, the brightness unevenness of the linear light sources 30 may be minimized by defining “d”, “n”, and θ of Equation (1) such that f(p)=p/(8×sin 18.4°). The aspect ratio AR of bottom face is not defined to 1.0, but may be within a range of 1≦AR≦5. In this regards, when AR is 1.0, the unevenness can be mitigated by way of equalizing the spaces between the virtual images since four virtual images generate per liner light source, meanwhile, an equal space between the virtual images is not necessarily optimal since the brightnesses of the virtual images are not constant when AR is other than 1.0.

When a prism sheet BEFII (by Sumitomo 3M Ltd.) having concave or convex V-shaped grooves (FIG. 14), for example, is used as the optional functional sheet 1, it is preferred that the aligning direction of the prisms 4 (direction to form V-shaped grooves) and the linear light sources 30 are disposed in parallel (inclination angle: 0°) thereby to generate two virtual images from one linear light source (e.g., linear light source 30A), and also the distance “d” between the optical functional sheet 1 and the linear light sources 30 is optimized. Under this condition, the brightness unevenness of the linear light sources 30 may be minimized by defining “d”, “n”, and θ of Equation (1) such that f(p)=p/4, or f(p)=3×p/4.

It is also preferable that two prism sheet BEFII (by Sumitomo 3M Ltd.) having concave or convex V-shaped grooves, for example, are used as the optional functional sheet 1 to place such that the ridge lines of two prism sheets are perpendicular and the aligning direction of prisms 4 of one prism sheet BEFII (e.g., one facing the linear light source 30) and the linear light source 30 forms an inclination angle of 26.6° (=tan⁻¹ ½) thereby to generate four virtual images from one linear light source (e.g., linear light source 30A), and also the distance “d” between the optical functional sheet 1 and the linear light sources 30 is optimized. Consequently, the light condensing ability and the diffusing ability may be further increased and the front brightness may be enhanced. Under this condition, the brightness unevenness of the linear light sources 30 may be minimized by defining “d”, “n”, and θ of Equation (1) such that f(p)=p/(8×(sin 26.6°+cos 26.6°) or f(p)=p/(6.5×(sin 26.6°+cos 26.6°).

In order to enhance the productivity or the diffusing ability, the top portion of prisms 4 may be flatted or rounded, or the bevel angle θ of prisms (angle of emitting face against reference face 3b) may be reduced. From the viewpoint of light condensing property, the bevel angle θ is preferably 40° to 50°, more preferably 44° to 46°. When the productivity or the diffusing ability should be enhanced even though the light condensing property is decreased, the bevel angle θ is preferably no more than 45° in order to suppress the sidelobe.

The odd number of emitting faces of the prisms 4 is undesirable since the angle (apex angle) between opposed emitting faces is other than 90° and the light condensing property is lowered.

When the prisms 4 are of a regular six-sided pyramid, a similar effect to mitigate unevenness may be expected since six virtual images can generate although the virtual images do not appear with an equal space.

It is difficult to produce the prisms 4 of regular seven-sided or more pyramid since the prisms cannot be disposed with no gap.

When the light source is not linear but point-like, the direction of fictive line that connects the point-like light sources is considered as the aligning direction of the linear light source.

The light diffusing function and the light condensing function may also be enhanced by way of incorporating diffusive particles into all of or a part of the optical functional sheet 1.

The diffusing ability can also be enhanced by way of somewhat decreasing the bevel angle θ along with going out from center to edge of the optical functional sheet 1 (e.g., 47° at center, 43° at edge). The diffusing ability can also be enhanced by way of somewhat widening the pitch of the linear light sources 30 along with going out from center of the optical functional sheet 1.

### EXAMPLES

The present invention will be explained with reference to Examples, but to which the present invention should not be limited at all.

### Example 1-A

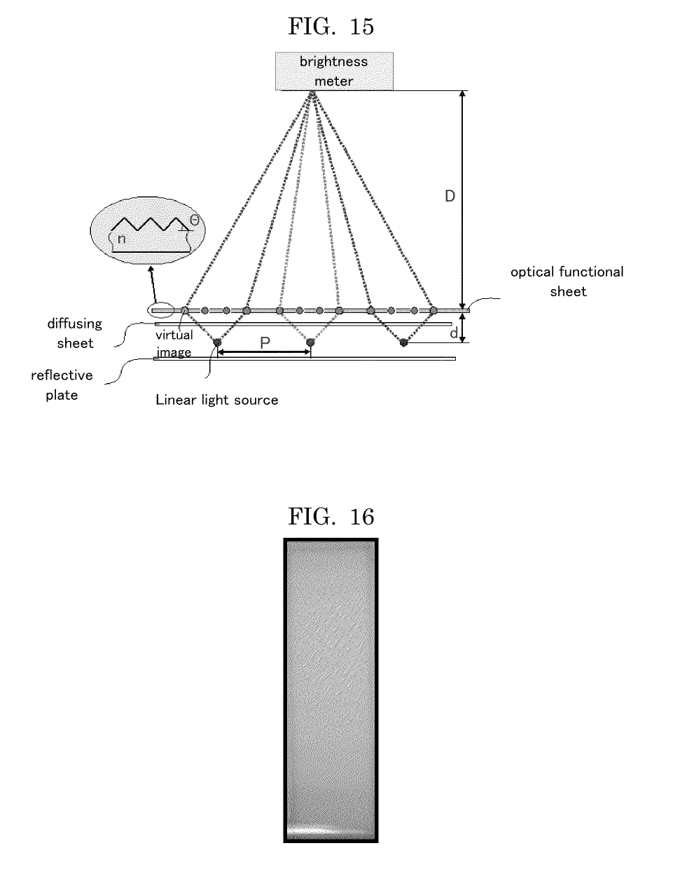

A sheet of 200 μm thick was formed by extrusion molding from a polycarbonate resin (refractive index: 1.59, by Mitsubishi Chemical Co.); then the sheet was heat-pressed by a mold having a convex regular four-sided pyramid pattern of 50 μm in bottom width and 25 μm in height under a condition of 200° C., 2 MPa, and 10 minutes, thereby to prepare an optical functional sheet of 17 cm square having a transferred pattern of concave regular four-sided pyramid (FIG. 3A). From the resulting optical functional sheet, cold cathode tubes of 3 mm in diameter as plural linear light sources aligned in parallel, a reflective plate (light box) to reflect a light from the cold cathode tubes, and a diffusing sheet (D121Z, by Tsujiden Co.) disposed between the cold cathode tubes and the optical functional sheet (FIG. 15), a backlight unit was prepared in a way that the optical functional sheet was disposed such that the aligning direction of prisms (regular four-sided pyramid) of the optical functional sheet was inclined 7° (83°) from the orientation direction of the cold cathode tubes. The cold cathode tubes were lighted up under the condition that the distance “d” between the cold cathode tubes and the optical functional sheet was 17 mm, the distance D between the optical functional sheet and the color brightness meter described later was 350 mm, and the alignment pitch “p” of the cold cathode tube was 23 mm; then the brightness of the optical functional sheet was measured by the color brightness meter (BM-7FAST, by Topcon Co.) in a direction perpendicular to the cold cathode tubes at even intervals, thereby an averaged brightness of one pitch between just above a cold cathode tube and just above the adjacent cold cathode tube and standard deviation of brightnesses were obtained, and the brightness unevenness was evaluated based on the following evaluation criteria.

value of brightness unevenness=(standard deviation of brightness)/(average of brightness)

### Evaluation Criteria of Brightness Unevenness

A: no brightness unevenness
B: a small level of brightness unevenness
C: some level of brightness unevenness
D: significant level of brightness unevenness

As a result, the average of brightness was 10,021 cd, the standard deviation of brightness was 57 cd, the value of (standard deviation of brightness)/(average of brightness) was 0.0057, and evaluation of brightness unevenness was C (Table 1).

In this regard, commercially, the diffusing degree of displays is further enhanced using a diffusing plate, etc., meanwhile, such a diffusing plate was not employed in Examples, since the brightness is emphasized and the effect to reduce the brightness unevenness can be easily confirmed.

### Example 2-A

A backlight unit was prepared and brightness was measured in the same manner as Example 1-A, except that the optical functional sheet was disposed in a way that the angle was 9° (81°) between the aligning direction of prisms (regular four-sided pyramid) of the optical functional sheet and the orientation direction of the cold cathode tubes. As a result, the average of brightness was 9,996 cd, the standard deviation of brightness was 43 cd, the value of (standard deviation of brightness)/(average of brightness) was 0.0043, and evaluation of brightness unevenness was B (Table 1).

### Example 3-A

A backlight unit was prepared and brightness was measured in the same manner as Example 1-A, except that the optical functional sheet was disposed in a way that the angle was 11° (79°) between the aligning direction of prisms (regular four-sided pyramid) of the optical functional sheet and the orientation direction of the cold cathode tubes. As a result, the average of brightness was 10,052 cd, the standard deviation of brightness was 26 cd, the value of (standard deviation of brightness)/(average of brightness) was 0.0025, and evaluation of brightness unevenness was A (Table 1).

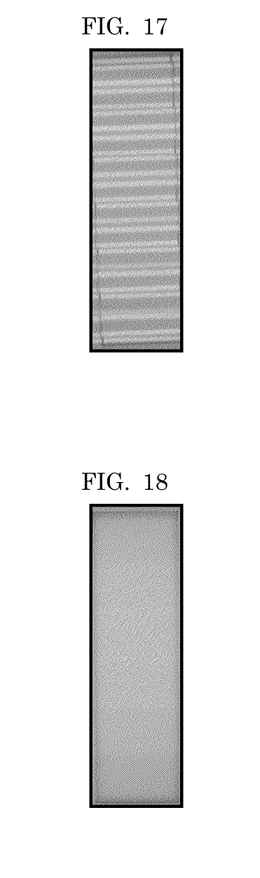

FIG. 16 shows an image that was photographed from above the optical functional sheet; and FIG. 17 shows an image in which the diffusing sheet (D121Z, by Tsujiden Co.) was not disposed between the cold cathode tubes and the optical functional sheet in order to make the virtual images more clear.

### Example 4-A

A backlight unit was prepared and brightness was measured in the same manner as Example 1-A, except that the optical functional sheet was disposed in a way that the angle was 13° (77°) between the aligning direction of prisms (regular four-sided pyramid) of the optical functional sheet and the orientation direction of the cold cathode tubes. As a result, the average of brightness was 9,999 cd, the standard deviation of brightness was 36 cd, the value of (standard deviation of brightness)/(average of brightness) was 0.0036, and evaluation of brightness unevenness was B (Table 1).

### Example 5-A

A backlight unit was prepared and brightness was measured in the same manner as Example 1-A, except that the optical functional sheet was disposed in a way that the angle was 18° (72°) between the aligning direction of prisms (regular four-sided pyramid) of the optical functional sheet and the orientation direction of the cold cathode tubes. As a result, the average of brightness was 9,994 cd, the standard deviation of brightness was 91 cd, the value of (standard deviation of brightness)/(average of brightness) was 0.0091, and evaluation of brightness unevenness was C (Table 1).

### Example 6-A

A backlight unit was prepared and brightness was measured in the same manner as Example 1-A, except that the optical functional sheet was disposed in a way that the aligning direction of prisms (regular four-sided pyramid) of the optical functional sheet and the orientation direction of the cold cathode tubes were parallel (inclination angle: 0° (90°)). As a result, the average of brightness was 10,074 cd, the standard deviation of brightness was 85 cd, the value of (standard deviation of brightness)/(average of brightness) was 0.0085, and evaluation of brightness unevenness was C (Table 1).

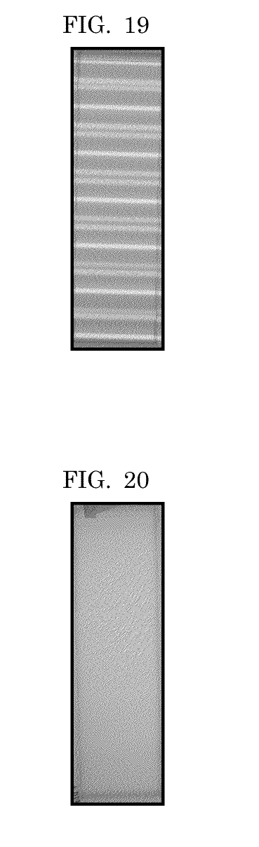

FIG. 18 shows an image that was photographed from above the optical functional sheet; and FIG. 19 shows an image in which the diffusing sheet (D121Z, by Tsujiden Co.) was not disposed between the cold cathode tubes and the optical functional sheet in order to make the virtual images more clear.

### Comparative Example 1-A

A backlight unit was prepared and brightness was measured in the same manner as Example 1-A, except that the optical functional sheet was disposed in a way that the angle was 27° (63°) between the aligning direction of prisms (regular four-sided pyramid) of the optical functional sheet and the orientation direction of the cold cathode tubes. As a result, the average of brightness was 9,996 cd, the standard deviation of brightness was 285 cd, the value of (standard deviation of brightness)/(average of brightness) was 0.0285, and evaluation of brightness unevenness was D (Table 1).

The results of Examples 1-A to 6-A and Comparative Example 1-A demonstrate that when the angle between the aligning direction of prisms (regular four-sided pyramid) of the optical functional sheet and the orientation direction of the cold cathode tubes is 0° to 18° (90° to 72°), preferably 7° to 13° (83° to 77°), more preferably 11° (79°), the value of (standard deviation of brightness)/(average of brightness) can be less than 0.0100, that is, the brightnesses of virtual images of the optical functional sheet derived from plural linear light sources can be approximately equivalent, and the distances between adjacent virtual images of the optical functional sheet derived from plural linear light sources can be approximately equivalent.

### Example 7-A

A backlight unit was prepared and brightness was measured in the same manner as Example 1-A, except that an optical functional sheet, having a transferred pattern of concave semi-four-sided pyramid of aspect ratio 1.5 (bottom face: 50 μm by 75 μm, height: 25 μm) (FIG. 4), was used in place of the optical functional sheet having a transferred pattern of concave regular four-sided pyramid (FIG. 3A), and the optical functional sheet was disposed in a way that the angle was 70° between the aligning direction of prisms (regular four-sided pyramid) of the optical functional sheet and the orientation direction of the cold cathode tubes. As a result, the average of brightness was 10,005 cd, the standard deviation of brightness was 48 cd, the value of (standard deviation of brightness)/(average of brightness) was 0.0048, and evaluation of brightness unevenness was B (Table 1).

### Example 8-A

A backlight unit was prepared and brightness was measured in the same manner as Example 7-A, except that the optical functional sheet was disposed in a way that the angle was 72° between the aligning direction of prisms (semi-four-sided pyramid) of the optical functional sheet and the orientation direction of the cold cathode tubes. As a result, the average of brightness was 9,793 cd, the standard deviation of brightness was 24 cd, the value of (standard deviation of brightness)/(average of brightness) was 0.0024, and evaluation of brightness unevenness was A (Table 1).

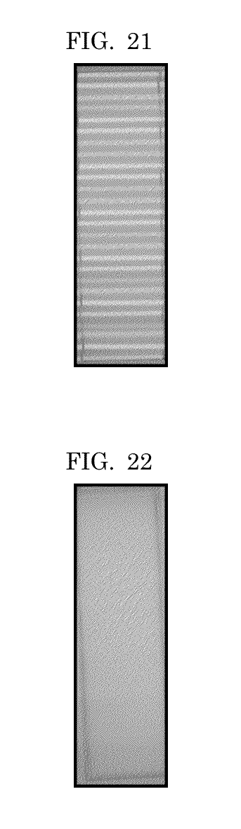

FIG. 20 shows an image that was photographed from above the optical functional sheet; and FIG. 21 shows an image in which the diffusing sheet (D121Z, by Tsujiden Co.) was not disposed between the cold cathode tubes and the optical functional sheet in order to make the virtual images more clear.

### Example 9-A

A backlight unit was prepared and brightness was measured in the same manner as Example 7-A, except that the optical functional sheet was disposed in a way that the angle was 74° between the aligning direction of prisms (semi-four-sided pyramid) of the optical functional sheet and the orientation direction of the cold cathode tubes. As a result, the average of brightness was 9,973 cd, the standard deviation of brightness was 65 cd, the value of (standard deviation of brightness)/(average of brightness) was 0.0065, and evaluation of brightness unevenness was B (Table 1).

### Comparative Example 2-A

A backlight unit was prepared and brightness was measured in the same manner as Example 7-A, except that the optical functional sheet was disposed in a way that the aligning direction of prisms (semi-four-sided pyramid) of the optical functional sheet and the orientation direction of the cold cathode tubes were parallel (inclination angle: 0°). As a result, the average of brightness was 10,157 cd, the standard deviation of brightness was 149 cd, the value of (standard deviation of brightness)/(average of brightness) was 0.0147, and evaluation of brightness unevenness was D (Table 1).

### Comparative Example 3-A

A backlight unit was prepared and brightness was measured in the same manner as Example 7-A, except that the optical functional sheet was disposed in a way that the angle was 63° between the aligning direction of prisms (semi-four-sided pyramid) of the optical functional sheet and the orientation direction of the cold cathode tubes. As a result, the average of brightness was 9,916 cd, the standard deviation of brightness was 181 cd, the value of (standard deviation of brightness)/(average of brightness) was 0.0182, and evaluation of brightness unevenness was D (Table 1).

### Comparative Example 4-A

A backlight unit was prepared and brightness was measured in the same manner as Example 7-A, except that the optical functional sheet was disposed in a way that the angle was 81° between the aligning direction of prisms (semi-four-sided pyramid) of the optical functional sheet and the orientation direction of the cold cathode tubes. As a result, the average of brightness was 9,844 cd, the standard deviation of brightness was 186 cd, the value of (standard deviation of brightness)/(average of brightness) was 0.0189, and evaluation of brightness unevenness was D (Table 1).

The results of Examples 7-A to 9-A and Comparative Examples 2-A to 4-A demonstrate that when the angle between the aligning direction of prisms of the optical functional sheet and the orientation direction of the cold cathode tubes is 70° to 74°, preferably 72°, the value of (standard deviation of brightness)/(average of brightness) can be less than 0.0100, that is, the brightnesses of virtual images of the optical functional sheet derived from plural linear light sources can be approximately equivalent, and the distances between adjacent virtual images of the optical functional sheet derived from plural linear light sources can be approximately equivalent.

### Example 10-A

A backlight unit was prepared and brightness was measured in the same manner as Example 1-A, except that a prism sheet having V-shaped grooves (RBEF, by Sumitomo 3M Ltd.) was used in place of the optical functional sheet having a transferred pattern of concave regular four-sided pyramid (FIG. 3A), and the optical functional sheet was disposed in a way that the angle was 63° between the aligning direction of V-shaped grooves of the prism sheet and the orientation direction of the cold cathode tubes. As a result, the average of brightness was 10,491 cd, the standard deviation of brightness was 91 cd, the value of (standard deviation of brightness)/(average of brightness) was 0.0087, and evaluation of brightness unevenness was C (Table 1).

### Example 11-A

A backlight unit was prepared and brightness was measured in the same manner as Example 10-A, except that the optical functional sheet was disposed in a way that the angle was 64° between the aligning direction of V-shaped grooves of the prism sheet and the orientation direction of the cold cathode tubes. As a result, the average of brightness was 10,520 cd, the standard deviation of brightness was 71 cd, the value of (standard deviation of brightness)/(average of brightness) was 0.0068, and evaluation of brightness unevenness was C (Table 1).

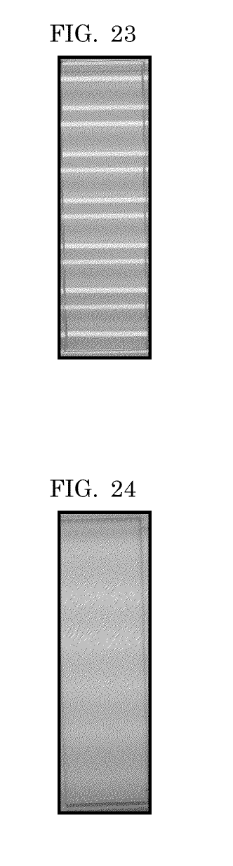

FIG. 22 shows an image that was photographed from above the optical functional sheet; and FIG. 23 shows an image in which the diffusing sheet (D121Z, by Tsujiden Co.) was not disposed between the cold cathode tubes and the optical functional sheet in order to make the virtual images more clear.

### Example 12-A

A backlight unit was prepared and brightness was measured in the same manner as Example 10-A, except that the optical functional sheet was disposed in a way that the angle was 65° between the aligning direction of V-shaped grooves of the prism sheet and the orientation direction of the cold cathode tubes. As a result, the average of brightness was 10,416 cd, the standard deviation of brightness was 94 cd, the value of (standard deviation of brightness)/(average of brightness) was 0.0090, and evaluation of brightness unevenness was C (Table 1).

### Comparative Example 5-A

A backlight unit was prepared and brightness was measured in the same manner as Example 10-A, except that the optical functional sheet was disposed in a way that the aligning direction of V-shaped grooves of the prism sheet and the orientation direction of the cold cathode tubes were parallel (inclination angle: 0°). As a result, the average of brightness was 11,176 cd, the standard deviation of brightness was 521 cd, the value of (standard deviation of brightness)/(average of brightness) was 0.0466, and evaluation of brightness unevenness was D (Table 1).

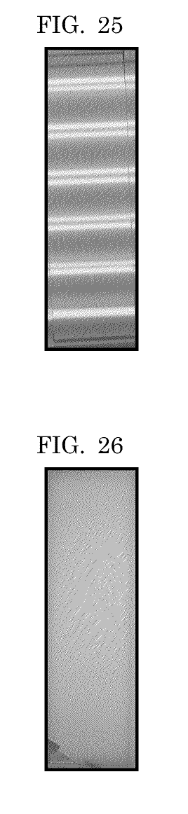

FIG. 24 shows an image that was photographed from above the optical functional sheet; and FIG. 25 shows an image in which the diffusing sheet (D121Z, by Tsujiden Co.) was not disposed between the cold cathode tubes and the optical functional sheet in order to make the virtual images more clear.

### Comparative Example 6-A

A backlight unit was prepared and brightness was measured in the same manner as Example 10-A, except that the optical functional sheet was disposed in a way that the angle was 59° between the aligning direction of V-shaped grooves of the prism sheet and the orientation direction of the cold cathode tubes. As a result, the average of brightness was 10,280 cd, the standard deviation of brightness was 201 cd, the value of (standard deviation of brightness)/(average of brightness) was 0.0195, and evaluation of brightness unevenness was D (Table 1).

### Comparative Example 7-A

A backlight unit was prepared and brightness was measured in the same manner as Example 10-A, except that the optical functional sheet was disposed in a way that the angle was 69° between the aligning direction of V-shaped grooves of the prism sheet and the orientation direction of the cold cathode tubes. As a result, the average of brightness was 10,384 cd, the standard deviation of brightness was 164 cd, the value of (standard deviation of brightness)/(average of brightness) was 0.0158, and evaluation of brightness unevenness was D (Table 1).

The results of Examples 10-A to 12-A and Comparative Examples 5-A to 7-A demonstrate that when the angle between the aligning direction of prisms of the optical functional sheet and the orientation direction of the cold cathode tubes is 63° to 65°, preferably 64°, the value of (standard deviation of brightness)/(average of brightness) can be less than 0.0100, that is, the brightnesses of virtual images of the optical functional sheet derived from plural linear light sources can be approximately equivalent, and the distances between adjacent virtual images of the optical functional sheet derived from plural linear light sources can be approximately equivalent.

### Example 13-A

A backlight unit was prepared and brightness was measured in the same manner as Example 1-A, except that two prism sheets having V-shaped grooves (RBEF, by Sumitomo 3M Ltd.) were used in place of the optical functional sheet having a transferred pattern of concave regular four-sided pyramid (FIG. 3A), two prism sheets were overlapped in a way that the directions of the V-shaped grooves were perpendicular, and the direction of V-shaped grooves of one prism sheet (facing the linear light source) was inclined 30° (60°) from the orientation direction of the cold cathode tubes. As a result, the average of brightness was 11,917 cd, the standard deviation of brightness was 104 cd, the value of (standard deviation of brightness)/(average of brightness) was 0.0088, and evaluation of brightness unevenness was C (Table 1).

### Example 14-A

A backlight unit was prepared and brightness was measured in the same manner as Example 13-A, except that the direction of V-shaped grooves of one prism sheet (facing the linear light source) was inclined 32° (58°) from the orientation direction of the cold cathode tubes. As a result, the average of brightness was 12,032 cd, the standard deviation of brightness was 67 cd, the value of (standard deviation of brightness)/(average of brightness) was 0.0055, and evaluation of brightness unevenness was C (Table 1).

### Example 15-A

A backlight unit was prepared and brightness was measured in the same manner as Example 13-A, except that the direction of V-shaped grooves of one prism sheet (facing the linear light source) was inclined 34° (56°) from the orientation direction of the cold cathode tubes. As a result, the average of brightness was 11,968 cd, the standard deviation of brightness was 54 cd, the value of (standard deviation of brightness)/(average of brightness) was 0.0046, and evaluation of brightness unevenness was B (Table 1).

### Example 16-A

A backlight unit was prepared and brightness was measured in the same manner as Example 13-A, except that the direction of V-shaped grooves of one prism sheet (facing the linear light source) was inclined 36° (54°) from the orientation direction of the cold cathode tubes. As a result, the average of brightness was 11,849 cd, the standard deviation of brightness was 18 cd, the value of (standard deviation of brightness)/(average of brightness) was 0.0015, and evaluation of brightness unevenness was A (Table 1).

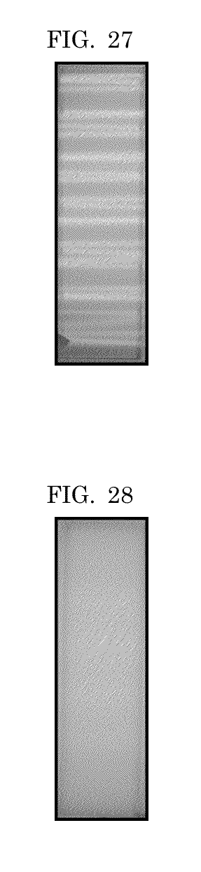

FIG. 26 shows an image that was photographed from above the optical functional sheet; and FIG. 27 shows an image in which the diffusing sheet (D121Z, by Tsujiden Co.) was not disposed between the cold cathode tubes and the optical functional sheet in order to make the virtual images more clear.

### Example 17-A

A backlight unit was prepared and brightness was measured in the same manner as Example 13-A, except that the direction of V-shaped grooves of one prism sheet (facing the linear light source) was inclined 45° from the orientation direction of the cold cathode tubes. As a result, the average of brightness was 11,981 cd, the standard deviation of brightness was 26 cd, the value of (standard deviation of brightness)/(average of brightness) was 0.0022, and evaluation of brightness unevenness was A (Table 1).

### Comparative Example 8-A

A backlight unit was prepared and brightness was measured in the same manner as Example 13-A, except that the direction of V-shaped grooves of one prism sheet (facing the linear light source) and the orientation direction of the cold cathode tubes were parallel (inclination angle: 0° (90°)). As a result, the average of brightness was 12,047 cd, the standard deviation of brightness was 120 cd, the value of (standard deviation of brightness)/(average of brightness) was 0.0100, and evaluation of brightness unevenness was D (Table 1).

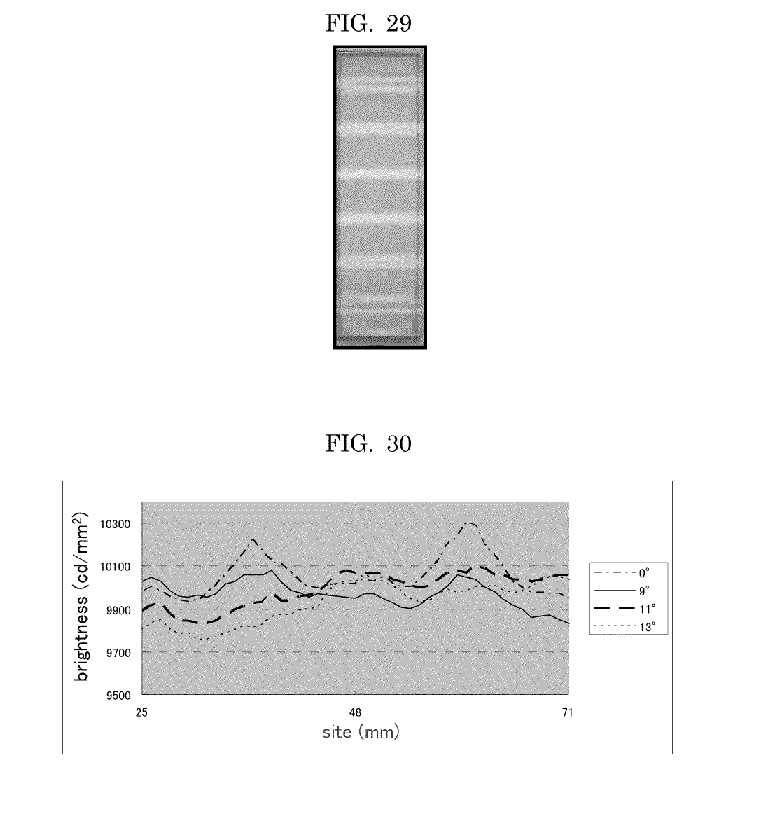

FIG. 28 shows an image that was photographed from above the optical functional sheet; and FIG. 29 shows an image in which the diffusing sheet (D121Z, by Tsujiden Co.) was not disposed between the cold cathode tubes and the optical functional sheet in order to make the virtual images more clear.

### Comparative Example 9-A

A backlight unit was prepared and brightness was measured in the same manner as Example 13-A, except that the direction of V-shaped grooves of one prism sheet (facing the linear light source) was inclined 27° (63°) from the orientation direction of the cold cathode tubes. As a result, the average of brightness was 11,928 cd, the standard deviation of brightness was 141 cd, the value of (standard deviation of brightness)/(average of brightness) was 0.0118, and evaluation of brightness unevenness was D (Table 1).

The results of Examples 13-A to 17-A and Comparative Examples 8-A to 9-A demonstrate that when the angle between the aligning direction of prisms of the optical functional sheet and the orientation direction of the cold cathode tubes is 30° to 45° (60° to 45°), preferably 36° (54°), the value of (standard deviation of brightness)/(average of brightness) can be less than 0.0100, that is, the brightnesses of virtual images of the optical functional sheet derived from plural linear light sources can be approximately equivalent, and the distances between adjacent virtual images of the optical functional sheet derived from plural linear light sources can be approximately equivalent.

### Reference Example 1-A

A backlight unit was prepared and brightness was measured in the same manner as Example 1-A, except that a prism sheet having V-shaped grooves (RBEF, by Sumitomo 3M Ltd.) was used in place of the optical functional sheet having a transferred pattern of concave regular four-sided pyramid (FIG. 3A), the optical functional sheet was disposed in a way that the angle was 0° between the aligning direction of V-shaped grooves of the prism sheet and the orientation direction of the cold cathode tubes, and the diffusing sheet (D121Z, by Tsujiden Co.) was not disposed. As a result, the average of brightness was 9,688 cd, the standard deviation of brightness was 4,674 cd, the value of (standard deviation of brightness)/(average of brightness) was 0.4825, and evaluation of brightness unevenness was D (Table 1).

### Reference Example 2-A

A backlight unit was prepared and brightness was measured in the same manner as Reference Example 1-A, except that the optical functional sheet was disposed in a way that the angle was 18° between the aligning direction of V-shaped grooves of the prism sheet and the orientation direction of the cold cathode tubes. As a result, the average of brightness was 9,715 cd, the standard deviation of brightness was 4,163 cd, the value of (standard deviation of brightness)/(average of brightness) was 0.4285, and evaluation of brightness unevenness was D (Table 1).

### Reference Example 3-A

A backlight unit was prepared and brightness was measured in the same manner as Reference Example 1-A, except that the optical functional sheet was disposed in a way that the angle was 36° between the aligning direction of V-shaped grooves of the prism sheet and the orientation direction of the cold cathode tubes. As a result, the average of brightness was 9,755 cd, the standard deviation of brightness was 3,613 cd, the value of (standard deviation of brightness)/(average of brightness) was 0.3704, and evaluation of brightness unevenness was D (Table 1).

### Reference Example 4-A

A backlight unit was prepared and brightness was measured in the same manner as Reference Example 1-A, except that the optical functional sheet was disposed in a way that the angle was 54° between the aligning direction of V-shaped grooves of the prism sheet and the orientation direction of the cold cathode tubes. As a result, the average of brightness was 9,528 cd, the standard deviation of brightness was 2,968 cd, the value of (standard deviation of brightness)/(average of brightness) was 0.3115, and evaluation of brightness unevenness was D (Table 1).

### Reference Example 5-A

A backlight unit was prepared and brightness was measured in the same manner as Reference Example 1-A, except that the optical functional sheet was disposed in a way that the angle was 72° between the aligning direction of V-shaped grooves of the prism sheet and the orientation direction of the cold cathode tubes. As a result, the average of brightness was 9,206 cd, the standard deviation of brightness was 3,264 cd, the value of (standard deviation of brightness)/(average of brightness) was 0.3546, and evaluation of brightness unevenness was D (Table 1).

### Reference Example 6-A

A backlight unit was prepared and brightness was measured in the same manner as Reference Example 1-A, except that the optical functional sheet was disposed in a way that the angle was 90° between the aligning direction of V-shaped grooves of the prism sheet and the orientation direction of the cold cathode tubes. As a result, the average of brightness was 9,253 cd, the standard deviation of brightness was 5,380 cd, the value of (standard deviation of brightness)/(average of brightness) was 0.5814, and evaluation of brightness unevenness was D (Table 1).

The results of Reference Examples 1-A to 6-A demonstrate that when the angle is 54° to 72° between the aligning direction of prisms of the optical functional sheet and the orientation direction of the cold cathode tubes, the value of (standard deviation of brightness)/(average of brightness) is relatively small than the case that the angle is 0°. That is, it is demonstrated that the value of (standard deviation of brightness)/(average of brightness) is approximately same whether or not the diffusing sheet (D121Z, by Tsujiden Co.) is disposed.

In this regard, when diffusing sheets having a higher haze value than that of the diffusing sheet (D121Z, by Tsujiden Co.) are used or plural diffusing sheets are used, it is considered that the optimum angle will be shifted from 45° as its center. For example, the optimum angle 20° will come to 18°, and the optimum angle 70° will come to 72°.

TABLE 1

| | Prism | Diffusing | Inclination | AB | SDB | | Brightness |
|---|---|---|---|---|---|---|---|
| | Shape | Sheet | Angle (°) | (cd) | (cd) | SDB/AB | Unevenness |
| Ex. 1-A | CRFP | exist | 7 | 10,021 | 57 | 0.0057 | C |
| Ex. 2-A | CRFP | exist | 9 | 9,996 | 43 | 0.0043 | B |
| Ex. 3-A | CRFP | exist | 11 | 10,052 | 26 | 0.0025 | A |
| Ex. 4-A | CRFP | exist | 13 | 9,999 | 36 | 0.0036 | B |
| Ex. 5-A | CRFP | exist | 18 | 9,994 | 91 | 0.0091 | C |
| Ex. 6-A | CRFP | exist | 0 | 10,074 | 85 | 0.0085 | C |
| Com. Ex. 1-A | CRFP | exist | 27 | 9,996 | 285 | 0.0285 | D |
| Ex. 7-A | CSP | exist | 70 | 10,005 | 48 | 0.0048 | B |
| Ex. 8-A | CSP | exist | 72 | 9,793 | 24 | 0.0024 | A |
| Ex. 9-A | CSP | exist | 74 | 9,973 | 65 | 0.0065 | B |
| Com. Ex. 2-A | CSP | exist | 0 | 10,157 | 149 | 0.0147 | D |
| Com. Ex. 3-A | CSP | exist | 63 | 9,916 | 181 | 0.0182 | D |
| Com. Ex. 4-A | CSP | exist | 81 | 9,844 | 186 | 0.0189 | D |
| Ex. 10-A | one V sheet | exist | 63 | 10,491 | 91 | 0.0087 | C |
| Ex. 11-A | one V sheet | exist | 64 | 10,520 | 71 | 0.0068 | C |
| Ex. 12-A | one V sheet | exist | 65 | 10,416 | 94 | 0.0090 | C |
| Com. Ex. 5-A | one V sheet | exist | 0 | 11,176 | 521 | 0.0466 | D |
| Com. Ex. 6-A | one V sheet | exist | 59 | 10,280 | 201 | 0.0195 | D |
| Com. Ex. 7-A | one V sheet | exist | 69 | 10,384 | 164 | 0.0158 | D |
| Ex. 13-A | two V sheet | exist | 30 | 11,917 | 104 | 0.0088 | C |
| Ex. 14-A | two V sheet | exist | 32 | 12,032 | 67 | 0.0055 | C |
| Ex. 15-A | two V sheet | exist | 34 | 11,968 | 54 | 0.0046 | B |
| Ex. 16-A | two V sheet | exist | 36 | 11,849 | 18 | 0.0015 | A |
| Ex. 17-A | two V sheet | exist | 45 | 11,981 | 26 | 0.0022 | A |
| Com. Ex. 8-A | two V sheet | exist | 0 | 12,047 | 120 | 0.0100 | D |
| Com. Ex. 9-A | two V sheet | exist | 27 | 11,928 | 141 | 0.0118 | D |
| Ref. Ex. 1-A | one V sheet | non | 0 | 9,688 | 4,674 | 0.4825 | D |
| Ref. Ex. 2-A | one V sheet | non | 18 | 9,715 | 4,163 | 0.4285 | D |
| Ref. Ex. 3-A | one V sheet | non | 36 | 9,755 | 3,613 | 0.3704 | D |
| Ref. Ex. 4-A | one V sheet | non | 54 | 9,528 | 2,968 | 0.3115 | D |
| Ref. Ex. 5-A | one V sheet | non | 72 | 9,206 | 3,264 | 0.3546 | D |
| Ref. Ex. 6-A | one V sheet | non | 90 | 9,253 | 5,380 | 0.5814 | D |

CRFP: concave regular four-sided pyramid (FIG. 3A)
CSP: concave semi-four-sided pyramid (FIG. 4A)
one V sheet: one prism sheet having V-shaped grooves
two V sheet: two prism sheets having V-shaped grooves
AB: average of brightness
SDB: standard deviation of brightness

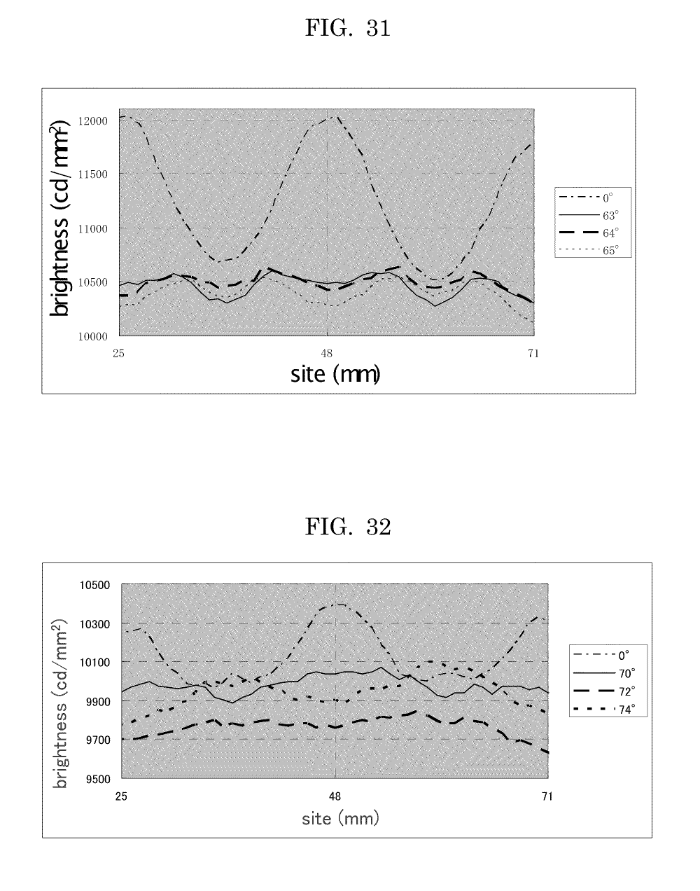

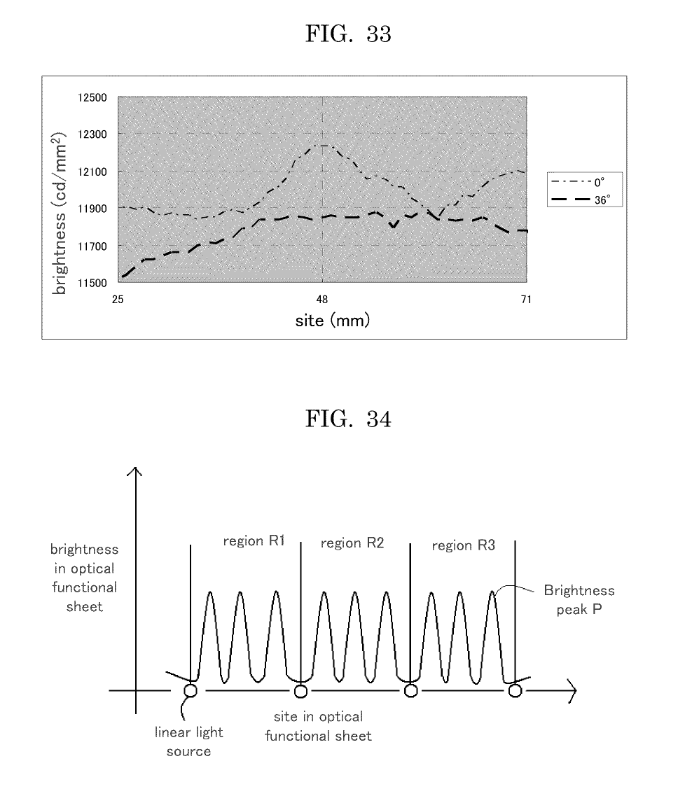

FIG. 30 shows brightness distributions in the optical functional sheets of Example 6-A (regular four-sided pyramid (FIG. 3A), inclination angle: 0°), Example 2-A (regular four-sided pyramid (FIG. 3A), inclination angle: 9°), Example 3-A (regular four-sided pyramid (FIG. 3A), inclination angle: 11°), and Example 4-A (regular four-sided pyramid (FIG. 3A), inclination angle: 13°); FIG. 31 shows brightness distributions in the optical functional sheets of Comparative Example 2-A (semi-four-sided pyramid (FIG. 4A), inclination angle: 0°), Example 7-A (semi-four-sided pyramid (FIG. 4A), inclination angle: 70°), Example 8-A (semi-four-sided pyramid (FIG. 4A), inclination angle: 72°), and Example 9-A (semi-four-sided pyramid (FIG. 4A), inclination angle: 74°); FIG. 32 shows brightness distributions in the optical functional sheets of Comparative Example 5-A (one sheet with V-shaped grooves, inclination angle: 0°), Example 10-A (one sheet with V-shaped grooves, inclination angle: 63°), Example 11-A (one sheet with V-shaped grooves, inclination angle: 64°), and Example 12-A (one sheet with V-shaped grooves, inclination angle: 65°); FIG. 33 shows brightness distributions in the optical functional sheets of Comparative Example 8-A (two sheets with V-shaped grooves, inclination angle: 0°) and Example 16-A (two sheets with V-shaped grooves, inclination angle: 36°).

In each of the brightness distribution graphs, the vertical line indicates the brightness (cd/mm²), the transverse line indicates the site (distance from a reference point), and linear light sources exist at the sites of 13.5 mm, 36.5 mm, 59.5 mm and 82.5 mm.

The results of FIGS. 30 to 33 demonstrate that when the aligning direction of prisms of the optical functional sheet is inclined at a certain angle from the orientation direction of linear light sources, the line of brightness distribution is more flat and the brightness unevenness is more reduced than the cases where the aligning direction of prisms of the optical functional sheet is not inclined from the orientation direction of linear light sources (inclination angle: 0°).

It is most preferable for the brightness distribution graph in the optical functional sheet that there exists no peak of brightness; however, even there exist brightness peaks P as shown in FIG. 34, for example, it is preferable that brightness peaks P exist in an approximately equivalent number and in an approximately equivalent height with an approximately equivalent space within each region of R1 to R3 from a linear light source to its adjacent light source, and the distance from the rightmost brightness peak P of region R1 (or R2) to the leftmost brightness peak P of region R2 (or R3) is approximately equivalent as the space of brightness peaks P within regions R1 to R3.

### Example 1-B

A sheet of 200 μm thick was formed by extrusion molding from a polycarbonate resin (refractive index: 1.59, by Mitsubishi Chemical Co.); then the sheet was heat-pressed by a mold having a convex pattern of aspect ratio 1.5 (bottom face: 50 μm by 75 μm, height: 25 μm) under a condition of 200° C., 2 MPa, and 10 minutes, thereby to prepare an optical functional sheet having a transferred pattern of concave regular four-sided pyramid (FIG. 9) (bevel angle θ: 45°). From the resulting optical functional sheet, cold cathode tubes as plural linear light sources aligned in parallel, and a reflective plate (light box) to reflect a light from the cold cathode tubes, a backlight unit was prepared in a way that the optical functional sheet was disposed such that the angle was parallel (0°) between the aligning direction of prisms (regular four-sided pyramid) of the optical functional sheet and the orientation direction of the cold cathode tubes. The cold cathode tubes were lighted up under the condition that the distance “d” between the cold cathode tubes and the optical functional sheet was 13.5 mm, the distance D between the optical functional sheet and the observing point (color brightness meter described later) was 350 mm, and the alignment pitch “p” of the cold cathode tube was 23 mm; then the brightness of the optical functional sheet was measured by the color brightness meter (BM-7FAST, by Topcon Co.) in a direction perpendicular to the cold cathode tubes at even intervals, thereby an averaged brightness of one pitch between just above a cold cathode tube to just above the adjacent cold cathode tube and standard deviation of brightnesses were obtained, and the brightness unevenness was evaluated based on the following evaluation criteria.

Value of brightness unevenness: (standard deviation of brightness)/(average of brightness)

### Evaluation Criteria of Brightness Unevenness

A: no brightness unevenness
B: a small level of brightness unevenness
C: some level of brightness unevenness
D: significant level of brightness unevenness

As a result, the average of brightness was 9,240 cd, the standard deviation of brightness was 3,220 cd, the value of (standard deviation of brightness)/(average of brightness) was 0.348, and evaluation of brightness unevenness was B (Table 2).

In this regard, commercially, the diffusing degree of displays is further enhanced using a diffusing plate, a diffusing sheet, etc., meanwhile, such a diffusing plate and a diffusing sheet were not employed in Examples, since the brightness is emphasized and the effect to reduce the brightness unevenness can be easily confirmed.

### Example 2-B

A backlight unit was prepared and brightness was measured in the same manner as Example 1-B, except that the distance “d” between the cold cathode tubes and the optical functional sheet was changed into 28.5 mm. As a result, the average of brightness was 9,310 cd, the standard deviation of brightness was 3,240 cd, the value of (standard deviation of brightness)/(average of brightness) was 0.348, and evaluation of brightness unevenness was B (Table 2).

### Comparative Example 1-B

A backlight unit was prepared and brightness was measured in the same manner as Example 1-B, except that the distance “d” between the cold cathode tubes and the optical functional sheet was changed into 5.0 mm. As a result, the average of brightness was 9,180 cd, the standard deviation of brightness was 5,020 cd, the value of (standard deviation of brightness)/(average of brightness) was 0.547, and evaluation of brightness unevenness was D (Table 2).

### Example 3-B

A backlight unit was prepared and brightness was measured in the same manner as Example 1-B, except that the distance “d” between the cold cathode tubes and the optical functional sheet was changed into 11.0 mm. As a result, the average of brightness was 9,370 cd, the standard deviation of brightness was 3,530 cd, the value of (standard deviation of brightness)/(average of brightness) was 0.377, and evaluation of brightness unevenness was C (Table 2).

### Example 4-B

A backlight unit was prepared and brightness was measured in the same manner as Example 1-B, except that the distance “d” between the cold cathode tubes and the optical functional sheet was changed into 16.0 mm. As a result, the average of brightness was 9,100 cd, the standard deviation of brightness was 3,470 cd, the value of (standard deviation of brightness)/(average of brightness) was 0.381, and evaluation of brightness unevenness was B (Table 2).

### Comparative Example 2-B

A backlight unit was prepared and brightness was measured in the same manner as Example 1-B, except that the distance “d” between the cold cathode tubes and the optical functional sheet was changed into 21.0 mm. As a result, the average of brightness was 9,150 cd, the standard deviation of brightness was 5,560 cd, the value of (standard deviation of brightness)/(average of brightness) was 0.608, and evaluation of brightness unevenness was D (Table 2).

### Example 5-B

A backlight unit was prepared and brightness was measured in the same manner as Example 1-B, except that the distance “d” between the cold cathode tubes and the optical functional sheet was changed into 26.0 mm. As a result, the average of brightness was 9,220 cd, the standard deviation of brightness was 3,470 cd, the value of (standard deviation of brightness)/(average of brightness) was 0.376, and evaluation of brightness unevenness was B (Table 2).

### Example 6-B

A backlight unit was prepared and brightness was measured in the same manner as Example 1-B, except that the distance “d” between the cold cathode tubes and the optical functional sheet was changed into 31.0 mm. As a result, the average of brightness was 9,160 cd, the standard deviation of brightness was 3,530 cd, the value of (standard deviation of brightness)/(average of brightness) was 0.385, and evaluation of brightness unevenness was C (Table 2).

### Comparative Example 3-B

A backlight unit was prepared and brightness was measured in the same manner as Example 1-B, except that the distance “d” between the cold cathode tubes and the optical functional sheet was changed into 45.0 mm. As a result, the average of brightness was 9,150 cd, the standard deviation of brightness was 8,380 cd, the value of (standard deviation of brightness)/(average of brightness) was 0.916, and evaluation of brightness unevenness was D (Table 2).

When the optimum “d” is calculated using Equation (1) such that f(p)=p/3, or f(p)=2×p/3, under the condition of Examples 1-B to 6-B and Comparative Examples 1-B to 3-B, “d” is calculated as 13.9 mm or 27.6 mm; and proper values of (standard deviation of brightness)/(average of brightness) were obtained (no more than 0.540) and the evaluation of brightness unevenness was B or C in the range of 8.9 to 18.9 mm or 22.6 to 32.6 mm.

### Example 7-B

A backlight unit was prepared and brightness was measured in the same manner as Example 1-B, except that a prism sheet BEFII (by Sumitomo 3M Ltd.) having V-shaped grooves (FIG. 14) was used in place of the optical functional sheet having a transferred pattern of concave semi-four-sided pyramid (FIG. 9) and the distance “d” between the cold cathode tubes and the optical functional sheet was changed into 9.8 mm. As a result, the average of brightness was 10,130 cd, the standard deviation of brightness was 4,920 cd, the value of (standard deviation of brightness)/(average of brightness) was 0.486, and evaluation of brightness unevenness was C (Table 2).

### Example 8-B

A backlight unit was prepared and brightness was measured in the same manner as Example 7-B, except that the distance “d” between the cold cathode tubes and the optical functional sheet was changed into 32.0 mm. As a result, the average of brightness was 10,430 cd, the standard deviation of brightness was 4,825 cd, the value of (standard deviation of brightness)/(average of brightness) was 0.463, and evaluation of brightness unevenness was C (Table 2).

### Example 9-B

A backlight unit was prepared and brightness was measured in the same manner as Example 7-B, except that the distance “d” between the cold cathode tubes and the optical functional sheet was changed into 5.0 mm. As a result, the average of brightness was 10,090 cd, the standard deviation of brightness was 5,438 cd, the value of (standard deviation of brightness)/(average of brightness) was 0.539, and evaluation of brightness unevenness was C (Table 2).

### Example 10-B

A backlight unit was prepared and brightness was measured in the same manner as Example 7-B, except that the distance “d” between the cold cathode tubes and the optical functional sheet was changed into 8.0 mm. As a result, the average of brightness was 10,320 cd, the standard deviation of brightness was 5,016 cd, the value of (standard deviation of brightness)/(average of brightness) was 0.486, and evaluation of brightness unevenness was C (Table 2).

### Example 11-B

A backlight unit was prepared and brightness was measured in the same manner as Example 7-B, except that the distance “d” between the cold cathode tubes and the optical functional sheet was changed into 12.0 mm. As a result, the average of brightness was 10,500 cd, the standard deviation of brightness was 4,959 cd, the value of (standard deviation of brightness)/(average of brightness) was 0.472, and evaluation of brightness unevenness was C (Table 2).

### Comparative Example 4-B

A backlight unit was prepared and brightness was measured in the same manner as Example 7-B, except that the distance “d” between the cold cathode tubes and the optical functional sheet was changed into 21.0 mm. As a result, the average of brightness was 10,250 cd, the standard deviation of brightness was 8,744 cd, the value of (standard deviation of brightness)/(average of brightness) was 0.853, and evaluation of brightness unevenness was D (Table 2).

### Example 12-B

A backlight unit was prepared and brightness was measured in the same manner as Example 7-B, except that the distance “d” between the cold cathode tubes and the optical functional sheet was changed into 30.0 mm. As a result, the average of brightness was 10,210 cd, the standard deviation of brightness was 4,911 cd, the value of (standard deviation of brightness)/(average of brightness) was 0.481, and evaluation of brightness unevenness was C (Table 2).

### Example 13-B

A backlight unit was prepared and brightness was measured in the same manner as Example 7-B, except that the distance “d” between the cold cathode tubes and the optical functional sheet was changed into 34.0 mm. As a result, the average of brightness was 10,370 cd, the standard deviation of brightness was 4,889 cd, the value of (standard deviation of brightness)/(average of brightness) was 0.471, and evaluation of brightness unevenness was C (Table 2).

### Comparative Example 5-B

A backlight unit was prepared and brightness was measured in the same manner as Example 7-B, except that the distance “d” between the cold cathode tubes and the optical functional sheet was changed into 45.0 mm. As a result, the average of brightness was 10,210 cd, the standard deviation of brightness was 8,382 cd, the value of (standard deviation of brightness)/(average of brightness) was 0.821, and evaluation of brightness unevenness was D (Table 2).

When the optimum “d” is calculated using Equation (1) such that f(p)=p/4, or f(p)=3×p/4, under the condition of Examples 7-B to 13-B and Comparative Examples 4-B and 5-B, “d” is calculated as 10.4 mm or 31.1 mm; and proper values of (standard deviation of brightness)/(average of brightness) were obtained (no more than 0.540) and the evaluation of brightness unevenness was B or C in the range of 5.4 to 15.4 mm or 26.1 to 36.1 mm.

### Example 14-B

A backlight unit was prepared and brightness was measured in the same manner as Example 1-B, except that an optical functional sheet having a transferred pattern of concave regular four-sided pyramid was used in place of the optical functional sheet having a transferred pattern of concave semi-four-sided pyramid (FIG. 9), the optical functional sheet was disposed in a way that the angle was 18.4° between the aligning direction of prisms of the optical functional sheet and the orientation direction of the cold cathode tubes (FIG. 13), and the distance “d” between the cold cathode tubes and the optical functional sheet was changed into 16.3 mm. As a result, the average of brightness was 9,410 cd, the standard deviation of brightness was 2,430 cd, the value of (standard deviation of brightness)/(average of brightness) was 0.258, and evaluation of brightness unevenness was A (Table 2).

### Example 15-B

A backlight unit was prepared and brightness was measured in the same manner as Example 14, except that the distance “d” between the cold cathode tubes and the optical functional sheet was changed into 27.0 mm. As a result, the average of brightness was 9,190 cd, the standard deviation of brightness was 2,834 cd, the value of (standard deviation of brightness)/(average of brightness) was 0.308, and evaluation of brightness unevenness was A (Table 2).

### Comparative Example 6-B

A backlight unit was prepared and brightness was measured in the same manner as Example 14, except that the distance “d” between the cold cathode tubes and the optical functional sheet was changed into 5.0 mm. As a result, the average of brightness was 9,180 cd, the standard deviation of brightness was 5,456 cd, the value of (standard deviation of brightness)/(average of brightness) was 0.594, and evaluation of brightness unevenness was D (Table 2).

### Example 16-B

A backlight unit was prepared and brightness was measured in the same manner as Example 14-B, except that the distance “d” between the cold cathode tubes and the optical functional sheet was changed into 14.0 mm. As a result, the average of brightness was 9,050 cd, the standard deviation of brightness was 2,766 cd, the value of (standard deviation of brightness)/(average of brightness) was 0.306, and evaluation of brightness unevenness was B (Table 2).

### Example 17-B

A backlight unit was prepared and brightness was measured in the same manner as Example 14-B, except that the distance “d” between the cold cathode tubes and the optical functional sheet was changed into 18.0 mm. As a result, the average of brightness was 9,260 cd, the standard deviation of brightness was 2,590 cd, the value of (standard deviation of brightness)/(average of brightness) was 0.280, and evaluation of brightness unevenness was A (Table 2).

### Example 18-B

A backlight unit was prepared and brightness was measured in the same manner as Example 14-B, except that the distance “d” between the cold cathode tubes and the optical functional sheet was changed into 22.0 mm. As a result, the average of brightness was 9,560 cd, the standard deviation of brightness was 4,000 cd, the value of (standard deviation of brightness)/(average of brightness) was 0.418, and evaluation of brightness unevenness was C (Table 2).

### Example 19-B

A backlight unit was prepared and brightness was measured in the same manner as Example 14-B, except that the distance “d” between the cold cathode tubes and the optical functional sheet was changed into 25.0 mm. As a result, the average of brightness was 9,440 cd, the standard deviation of brightness was 2,898 cd, the value of (standard deviation of brightness)/(average of brightness) was 0.307, and evaluation of brightness unevenness was B (Table 2).

### Example 20-B

A backlight unit was prepared and brightness was measured in the same manner as Example 14-B, except that the distance “d” between the cold cathode tubes and the optical functional sheet was changed into 29.0 mm. As a result, the average of brightness was 9,640 cd, the standard deviation of brightness was 2,910 cd, the value of (standard deviation of brightness)/(average of brightness) was 0.302, and evaluation of brightness unevenness was B (Table 2).

### Example 21-B

A backlight unit was prepared and brightness was measured in the same manner as Example 14-B, except that the distance “d” between the cold cathode tubes and the optical functional sheet was changed into 34.0 mm. As a result, the average of brightness was 9,090 cd, the standard deviation of brightness was 4,894 cd, the value of (standard deviation of brightness)/(average of brightness) was 0.538, and evaluation of brightness unevenness was C (Table 2).

When the optimum “d” is calculated using Equation (1) such that f(p)=p/(8×sin 18.4°), or f(p)=p/(5×sin 18.4°), under the condition of Examples 14-B to 21-B and Comparative Example 6-B, “d” is calculated as 16.4 mm or 26.3 mm; and proper values of (standard deviation of brightness)/(average of brightness) were obtained (no more than 0.540) and the evaluation of brightness unevenness was A, B or C in the range of 11.4 to 21.4 mm and 21.3 to 31.3 mm.

The graph of FIG. 37 shows the relation between the distance “d” from the linear light source to the optical functional sheet and the standard deviation of brightness (brightness unevenness) (result of simulation calculation of unevenness evaluation); in which the shape of prisms 4 is semi-four-sided pyramid having a bottom-face aspect ratio AR of 1.5 (FIG. 9), V-shaped grooves are formed (FIG. 14), and the shape of prisms 4 is regular four-sided pyramid having a bottom-face aspect ratio AR of 1.0 (FIG. 13). It is believed that the effect is sufficient when being in the range of no more than 500 from the optimum value (local minimum value of standard deviation) of the standard deviation of brightness as the vertical axis of the graph, and the allowable range of “d” is considered as ((optimum value of “d” obtained from Equation (1)) ±5 mm). In this regard, the number of virtual images increases in view of typical reflective plates, therefore, it is preferred that the lower limit of the allowable range of ‘d’ is lowered 3 mm ((optimum value of “d” obtained from Equation (1)) −8 mm) and it is also preferred in view of typical diffusing plates or diffusing sheets that the upper limit of the allowable range of ‘d’ is increased 3 mm ((optimum value of “d” obtained from Equation (1)) +8 mm).

TABLE 2

| | Prism | Distance | Inclination | AB | SDB | | Brightness |
|---|---|---|---|---|---|---|---|
| | Shape | d (mm) | Angle (°) | (cd) | (cd) | SDB/AB | Unevenness |
| Ex. 1-B | CSP | 13.5 | 0 | 9,240 | 3,220 | 0.348 | B |
| Ex. 2-B | CSP | 28.5 | 0 | 9,310 | 3,240 | 0.348 | B |
| Com. Ex. 1-B | CSP | 5.0 | 0 | 9,180 | 5,020 | 0.547 | D |
| Ex. 3-B | CSP | 11.0 | 0 | 9,370 | 3,530 | 0.377 | C |
| Ex. 4-B | CSP | 16.0 | 0 | 9,100 | 3,470 | 0.381 | B |
| Com. Ex. 2-B | CSP | 21.0 | 0 | 9,150 | 5,560 | 0.608 | D |
| Ex. 5-B | CSP | 26.0 | 0 | 9,220 | 3,470 | 0.376 | B |
| Ex. 6-B | CSP | 31.0 | 0 | 9,160 | 3,530 | 0.385 | C |
| Com. Ex. 3-B | CSP | 45.0 | 0 | 9,150 | 8,380 | 0.916 | D |
| Ex. 7-B | one V sheet | 9.8 | 0 | 10,130 | 4,920 | 0.486 | C |
| Ex. 8-B | one V sheet | 32.0 | 0 | 10,430 | 4,825 | 0.463 | C |
| Ex. 9-B | one V sheet | 5.0 | 0 | 10,090 | 5,438 | 0.539 | C |
| Ex. 10-B | one V sheet | 8.0 | 0 | 10,320 | 5,016 | 0.486 | C |
| Ex. 11-B | one V sheet | 12.0 | 0 | 10,500 | 4,959 | 0.472 | C |
| Com. Ex. 4-B | one V sheet | 21.0 | 0 | 10,250 | 8,744 | 0.853 | D |
| Ex. 12-B | one V sheet | 30.0 | 0 | 10,210 | 4,911 | 0.481 | C |
| Ex. 13-B | one V sheet | 34.0 | 0 | 10,370 | 4,889 | 0.471 | C |
| Com. Ex. 5-B | one V sheet | 45.0 | 0 | 10,210 | 8,382 | 0.821 | D |
| Ex. 14-B | CRFP | 16.3 | 18.4 | 9,410 | 2,430 | 0.258 | A |
| Ex. 15-B | CRFP | 27.0 | 18.4 | 9,190 | 2,834 | 0.308 | A |
| Com. Ex. 6-B | CRFP | 5.0 | 18.4 | 9,180 | 5,456 | 0.594 | D |
| Ex. 16-B | CRFP | 14.0 | 18.4 | 9,050 | 2,766 | 0.306 | B |
| Ex. 17-B | CRFP | 18.0 | 18.4 | 9,260 | 2,590 | 0.280 | A |
| Ex. 18-B | CRFP | 22.0 | 18.4 | 9,560 | 4,000 | 0.418 | C |
| Ex. 19-B | CRFP | 25.0 | 18.4 | 9,440 | 2,898 | 0.307 | B |
| Ex. 20-B | CRFP | 29.0 | 18.4 | 9,640 | 2,910 | 0.302 | B |
| Ex. 21-B | CRFP | 34.0 | 18.4 | 9,090 | 4,894 | 0.538 | C |

CSP: concave semi-four-sided pyramid (FIG. 9)
one V sheet: one prism sheet having V-shaped grooves (FIG. 14)
CRFP: concave regular four-sided pyramid (FIG. 13)

### INDUSTRIAL APPLICABILITY

The backlight units according to the present invention can advance the light diffusing function and also decrease the unevenness of linear light sources without decreasing the light condensing function, generating the sidelobe, or decreasing productivity etc, therefore, can be appropriately used to control light-emitting efficiency and/or light-emitting properties in various displays, display devices, lighting systems, etc. of liquid crystal display systems, organic ELs, etc.

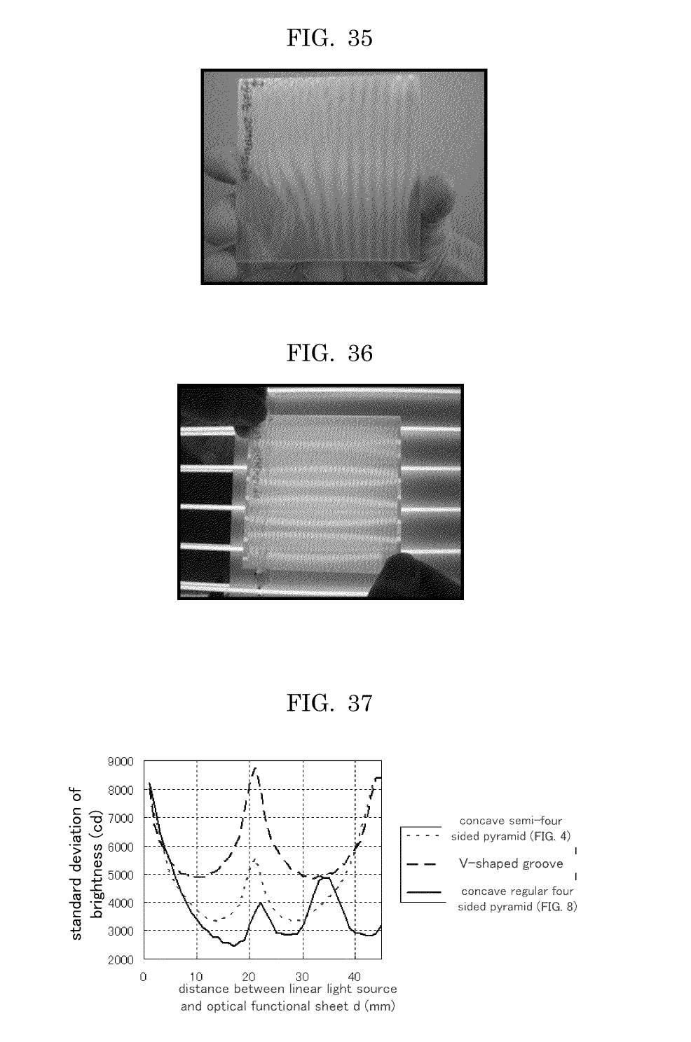

The optical functional sheet can be used as a reflective plate by way of making the apex angle of the optical functional sheet of the backlight to about 170° and vapor-depositing a metal. Thereby the brightness unevenness may be reduced, utility efficiency may be increased, and moire (FIGS. 35, 36) may be prevented.

1. A backlight unit, comprising:
plural linear light sources, and
an optical functional sheet,
wherein a prism structure having plural prisms is formed on at least one surface of the optical functional sheet, and the values of (Hₙ₋₁+Hₙ)/(Aₙ−Aₙ₋₁) are approximately equivalent,
wherein, in a brightness distribution graph that expresses a brightness distribution in the optical functional sheet, Bmax is the maximum brightness and Bmin is the minimum brightness at a portion on the optical functional sheet relative to the central portion of the backlight unit; A₁ is a peak site and H₁ is a peak height of a first virtual image, A₂ is a peak site and H₂ is a peak height of a second virtual image adjacent to the first virtual image, . . . , Aₙ₋₁ is a peak site and Hₙ₋₁ is a peak height of (n−1)th virtual image adjacent to (n−2)th virtual image, and Aₙ is a peak site and Hₙ is a peak height of (n)th virtual image adjacent to (n−1)th virtual image, and these virtual images are derived from the plural linear light sources, and
the virtual image corresponds to a peak of which the peak height Hₙ satisfies the condition of Hₙ≧0.3×(Bmax−Bmin); and the brightness distribution graph represents a brightness distribution of the optical functional sheet in which the backlight unit is equipped with neither a diffusing sheet nor a diffusing plate.

2. The backlight unit according to claim 1, wherein the ratios of the sum of the peak height of one virtual image, among the plural virtual images derived from the plural linear light sources, and the peak height of the virtual image adjacent to the one virtual image, to the distance between the peek sites of the adjacent images, are approximately equivalent.

3. A backlight unit, comprising:
plural linear light sources, and
an optical functional sheet,
wherein a prism structure having plural prisms is formed on at least one surface of the optical functional sheet,
virtual images of the optical functional sheet derived from the plural linear light sources are approximately equivalent in terms of their brightnesses, and
distances between adjacent virtual images of the optical functional sheet are approximately equivalent.

4. The backlight unit according to claim 3, wherein brightness peaks exist in an approximately equivalent number and in an approximately equivalent height with an approximately equivalent space within each region of R₁ to Rₙ, in a brightness distribution graph that expresses brightness distribution in the optical functional sheet,
wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among the plural linear light sources.

5. The backlight unit according to claim 1, wherein the backlight unit further comprises a diffusing sheet, the value of standard deviation of brightness within region Rₙ of the optical functional sheet divided by the average value of brightness within region Rₙ of the optical functional sheet is less than 0.0100,
wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among the plural linear light sources.

6. The backlight unit according to claim 1, wherein the aligning direction of prisms is inclined from the orientation direction of the linear light sources.

7. The backlight unit according to claim 1, wherein the distance “d” between the linear light sources and the optical functional sheet is selected such that the values of (Hₙ₋₁+Hₙ)/(Aₙ−Aₙ₋₁) are approximately constant.

8. The backlight unit according to claim 7, wherein the ratios of the sum of the peak height of one virtual image, among the plural virtual images derived from the plural linear light sources, and the peak height of the virtual image adjacent to the one virtual image, to the distance between the peek sites of the adjacent images, are approximately equivalent.

9. The backlight unit according to claim 3, wherein the distance “d” between the linear light sources and the optical functional sheet is selected such that the distances between adjacent virtual images are approximately constant in the optical functional sheet.

10. The backlight unit according to claim 7, wherein the value of standard deviation of brightness within a region Rₙ of the optical functional sheet divided by the average value of brightness within the region Rₙ of the optical functional sheet is no more than 0.540,
wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among the plural linear light sources.

11. The backlight unit according to claim 7, wherein the distance “d” between the linear light sources and the optical functional sheet is calculated from Equation (1) below based on a refractive index “n” of the optical functional sheet, a bevel angle θ of the emitting face of the prisms against light emitted from the linear light sources, and a pitch “p” of the linear light sources,
d=(f(p)−27.9n−0.473θ+65.7)/0.557±5 mm Equation (1)
wherein f(p) is a distance between a nodal line and a virtual image that is the nearest to the nodal line, and is a function of the pitch “p”; in which the nodal line is one between a flat surface, which containing a linear light source among the plural linear light sources and being perpendicular to the optical functional sheet, and a flat surface, which containing the optical functional sheet; the virtual image is one except for ones on the nodal line among the virtual images of the optical functional sheet derived from a linear light source.

12. The backlight unit according to claim 7, wherein each of the prisms is a semi-four-sided pyramid, and has two first emitting faces opposing each other and two second emitting faces opposing each other, a sum of areas of the two first emitting faces is approximately equivalent with the area of one of the two second emitting faces, and f(p) is approximately p/3 or approximately 2p/3, when the aligning direction of the prisms is parallel to the orientation direction of the linear light sources,
wherein f(p) is a distance between a nodal line and a virtual image that is the nearest to the nodal line, and is a function of the pitch “p”; in which the nodal line is one between a flat surface, which containing a linear light source among the plural linear light sources and being perpendicular to the optical functional sheet, and a flat surface, which containing the optical functional sheet; the virtual image is one except for ones on the nodal line among the virtual images of the optical functional sheet derived from a linear light source.

13. The backlight unit according to claim 7, wherein the optical functional sheet having the prisms with V-shaped grooves is disposed, and f(p) is approximately p/4 or approximately 3p/4, when the aligning direction of the prisms is parallel to the orientation direction of the linear light sources,
wherein f(p) is a distance between a nodal line and a virtual image that is the nearest to the nodal line, and is a function of the pitch “p”; in which the nodal line is one between a flat surface, which containing a linear light source among the plural linear light sources and being perpendicular to the optical functional sheet, and a flat surface, which containing the optical functional sheet; the virtual image is one except for ones on the nodal line among the virtual images of the optical functional sheet derived from a linear light source.

14. The backlight unit according to claim 7, wherein each of the prisms is a regular four-sided pyramid, and f(p) is approximately p/(8×sin X°) or approximately p/(5×sin X°), when the aligning direction of the prisms is inclined by X° from the orientation direction of the linear light sources.
wherein f(p) is a distance between a nodal line and a virtual image that is the nearest to the nodal line, and is a function of the pitch “p”; in which the nodal line is one between a flat surface, which containing a linear light source among the plural linear light sources and being perpendicular to the optical functional sheet, and a flat surface, which containing the optical functional sheet; the virtual image is one except for ones on the nodal line among the virtual images of the optical functional sheet derived from a linear light source.

15. The backlight unit according to claim 7, wherein the backlight unit further comprises another optical functional sheet, and the two optical functional sheets having the prisms with V-shaped grooves are disposed orthogonally, and f(p) is approximately p/(8×sin X°+8×cos X°) or approximately p/(6.5×sin X°+6.5×cos X°), when the aligning direction of the prisms of one optical functional sheet is inclined by X° from the orientation direction of the linear light sources,
wherein f(p) is a distance between a nodal line and a virtual image that is the nearest to the nodal line, and is a function of the pitch “p”; in which the nodal line is one between a flat surface, which containing a linear light source among the plural linear light sources and being perpendicular to the optical functional sheet, and a flat surface, which containing the optical functional sheet; the virtual image is one except for ones on the nodal line among the virtual images of the optical functional sheet derived from a linear light source.

16. The backlight unit according to claim 3, wherein the backlight unit further comprises a diffusing sheet, the value of standard deviation of brightness within region Rₙ of the optical functional sheet divided by the average value of brightness within region Rₙ of the optical functional sheet is less than 0.0100,
wherein, R₁ is the region from a first light source to a second light source adjacent to the first light source, R₂ is the region from the second light source to a third light source adjacent to the second light source, . . . , Rₙ₋₁ is the region from a (n−1)th light source to a (n)th light source adjacent to the (n−1)th light source, and Rₙ is the region from the (n)th light source to a (n+1)th light source adjacent to the (n)th light source, among the plural linear light sources.

17. The backlight unit according to claim 3, wherein the aligning direction of prisms is inclined from the orientation direction of the linear light sources.
